(19) United States
(12) Patent Application Publication
(10) Pub. No.: US 2022/0169251 A1
(43) Pub. Date: Jun. 2, 2022

(54) VEHICLE CONTROL DEVICE

(71) Applicant: ADVICS CO., LTD., Kariya-shi, Aichi-ken (JP)

(72) Inventors: Sotaro MURAMATSU, Kariya-shi, Aichi-ken (JP); Yosuke HASHIMOTO, Kariya-shi, Aichi-ken (JP)

(73) Assignee: ADVICS CO., LTD., Kariya-shi, Aichi-ken (JP)

(21) Appl. No.: 17/441,995

(22) PCT Filed: Mar. 30, 2020
(86) PCT No.: PCT/JP2020/014559

§ 371 Date: Sep. 22, 2021

(30) Foreign Application Priority Data
Mar. 29, 2019 (JP) 2019-066152
Mar. 27, 2020 (JP) 2020-056997

(51) Int. Cl. B60W 30/18; B60W 10/04; B60W 10/184

(52) U.S. Cl. CPC B60W 30/18118; B60W 10/04; B60W 2520/40; B60W 2552/15; B60W 10/184

(57) ABSTRACT

An orientation control device serving as a control device includes: an orientation control unit configured to, in a case where a vehicle is stopped on a slope road by applying braking force to a front wheel and a rear wheel, instruct a braking device to decrease front wheel braking force and rear wheel braking force and execute orientation control for instructing a drive device to increase drive force of the vehicle in a range in which a stop state of the vehicle is maintained; and a braking increase instruction unit configured to execute braking increase control for instructing the braking device to increase the braking force of at least one of the front wheel and the rear wheel after the increase in the drive force of the vehicle in accordance with the execution of the orientation control is ended.

### TECHNICAL FIELD

The present disclosure relates to a vehicle control device that controls a drive device and a braking device.

### BACKGROUND ART

Patent Literature 1 describes an example of a vehicle control device that stops a vehicle on an up-hill road. In this control device, drive force of the vehicle is decreased by controlling the drive device, and braking force of the vehicle is increased by controlling a braking device, such that the vehicle is stopped on the up-hill road.

### CITATIONS LIST

### Patent Literature

Patent Literature 1: JP 2018-90064 A

### SUMMARY

### Technical Problems

Meanwhile, at the time of braking the vehicle, the vehicle may perform a pitching motion in a nose dive direction. In this case, a front-rear direction position of at least one of a front wheel and a rear wheel changes due to contraction of a suspension for the front wheel and extension of a suspension for the rear wheel, and a wheel base of the vehicle may change. In a case where application of the braking force to the at least one wheel is continued, friction force between the wheel and a road surface and braking force applied to the wheel regulate an operation of the suspension to return the state in which the suspension is contracted or extended to an original state, that is, regulate displacement of the wheel to return the front-rear direction position of the wheel to an original position. Therefore, when the application of the braking force to each wheel is released when the vehicle is started, a regulation of the operation of the suspension is released, the state of the suspension returns to the original state, and the front-rear direction position of the at least one wheel returns to the original position. As a result, the state in which the wheel base of the vehicle changes is released. At this time, an orientation of the vehicle may suddenly change due to the change of the wheel base. Furthermore, a sound may be generated with a sudden change in the vehicle orientation. There is a possibility that an occupant of the vehicle feels uncomfortable with such a sudden change in the vehicle orientation at the time of the vehicle is started.

### Solutions to Problems

A vehicle control device for solving the above problem is a device that controls a drive device and a braking device of a vehicle. This control device includes: an orientation control unit configured to, in a case where the vehicle is stopped on a slope road by applying braking force to a front wheel and a rear wheel of the vehicle, instruct the braking device to decrease braking force of the front wheel and braking force of the rear wheel, and execute orientation control for instructing drive device to increase drive force of the vehicle in a range in which a stop state of the vehicle is maintained; and a braking increase instruction unit configured to execute braking increase control for instructing the braking device to increase the braking force of at least one of the front wheel and the rear wheel after the increase in the drive force of the vehicle in accordance with to the execution of the orientation control is ended.

According to the configuration described above, the orientation control is executed when the vehicle is stopped on the slope road by applying the braking force to the front wheel and the rear wheel. When an instruction based on the orientation control is input to the braking device and the drive device, the braking force of the front wheel and the rear wheel is decreased. Furthermore, the drive force of the vehicle is increased such that the stop state of the vehicle is maintained even when the braking force of the vehicle is decreased. According to this, even when the front-rear direction position of at least one of the front wheel and the rear wheel is displaced when the vehicle is stopped and the wheel base of the vehicle is changed, the front-rear direction position of the at least one wheel can be returned to the original position while the stop state of the vehicle is maintained by the execution of the orientation control. That is, the wheel base can be returned to an original state while the vehicle is stopped. Then, after the increase in the drive force for maintaining the stop state of the vehicle is ended, the braking force of the vehicle is increased by the execution of the braking increase control. Therefore, when the braking of the vehicle is released at the time of subsequent start of the vehicle, a sudden change in the vehicle orientation due to the change in the wheel base does not occur. Accordingly, it is possible to prevent the occupant of the vehicle from feeling discomfort when the vehicle is started.

### BRIEF DESCRIPTION OF DRAWINGS

FIG. 1 is a block diagram illustrating an orientation control device which is a vehicle control device, a drive device, and a braking device according to a first embodiment.

FIG. 2 is a schematic diagram of a vehicle on which the orientation control device is mounted.

FIG. 3 is a schematic diagram illustrating a state in which the vehicle travels on an up-hill road.

FIG. 4 is a schematic diagram illustrating a state in which the vehicle is stopped on an up-hill road.

FIG. 5 is a flowchart illustrating a processing routine executed by the orientation control device.

FIG. 6 is a flowchart illustrating a processing routine executed by the orientation control device.

FIG. 7 is a flowchart illustrating a processing routine for instructing a decrease in braking force of a first wheel and an increase in drive force of a vehicle.

FIG. 8 is a flowchart illustrating a processing routine for instructing an increase in drive force of a vehicle.

FIG. 9 is a flowchart illustrating a processing routine for instructing a decrease in braking force of a second wheel.

FIG. 10 is a flowchart illustrating a processing routine for instructing an increase in braking force of a second wheel and a decrease in drive force of a vehicle.

FIG. 11 is a flowchart illustrating a processing routine for instructing an increase in braking force of a first wheel and a decrease in drive force of a vehicle.

FIGS. 12A to 12F are timing charts according to a first embodiment.

FIGS. 13A to 13F are timing charts according to a first embodiment.

FIG. 14 is a flowchart illustrating a processing routine for instructing an increase in drive force of a vehicle according to a second embodiment.

FIGS. 15A to 15F are timing charts according to a second embodiment.

FIGS. 16A to 16F are timing charts according to a third embodiment.

FIGS. 17A to 17F are timing charts according to a modified example.

### DESCRIPTION OF EMBODIMENTS

### First Embodiment

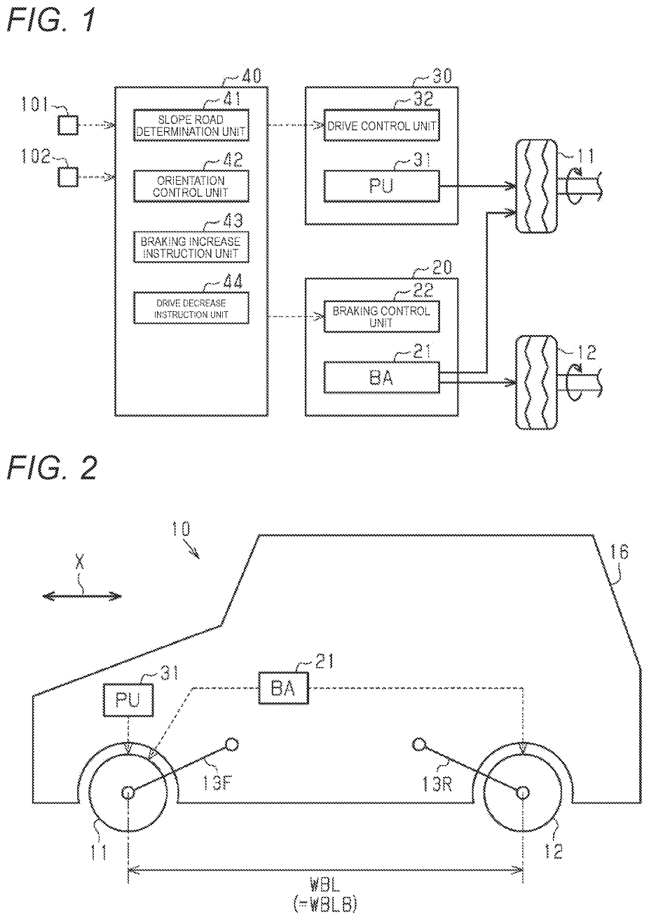

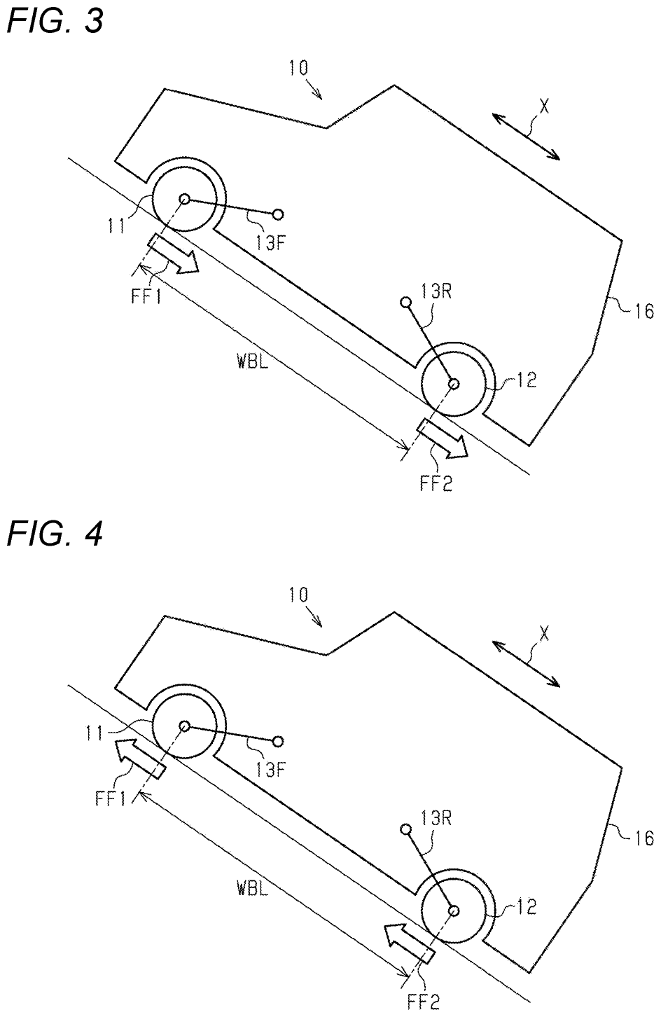

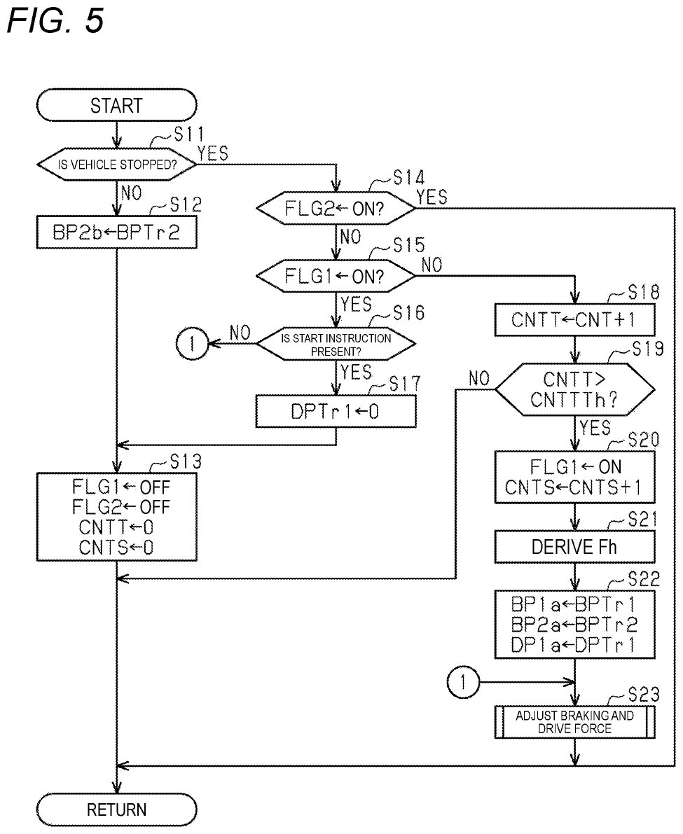

Hereinafter, a first embodiment of a vehicle control device will be described with reference to FIGS. 1 to 13.

FIG. 1 illustrates an orientation control device 40 which is an example of a control device, a braking device 20, and a drive device 30 according to the present embodiment. The drive device 30 includes a power unit 31 and a drive control unit 32 that controls the power unit 31. The power unit 31 includes at least one of an engine and an electric motor as a power source of the vehicle. The drive control unit 32 adjusts drive force DP of the vehicle by controlling the power unit 31. Note that, as illustrated in FIGS. 1 and 2, the power unit 31 outputs the drive force DP to a front wheel 11 and does not output the drive force DP to a rear wheel 12 among a plurality of wheels 11 and 12 provided in the vehicle. That is, in the present embodiment, the front wheel 11 corresponds to a “first wheel”, and the rear wheel 12 corresponds to a “second wheel”.

As illustrated in FIG. 1, the braking device 20 includes a braking actuator 21 and a braking control unit 22 that controls the braking actuator 21. As illustrated in FIGS. 1 and 2, the braking actuator 21 is configured to be capable of individually controlling the braking force of the front wheel 11 and the braking force of the rear wheel 12. The braking force of the front wheel 11 is also referred to as “front wheel braking force BPF”, and the braking force of the rear wheel 12 is also referred to as “rear wheel braking force BPR”. The braking control unit 22 adjusts braking force BP of the vehicle by controlling the braking actuator 21. The braking force BP of the vehicle is a sum of the braking force of all the wheels 11 and 12.

A transition of a vehicle orientation when a vehicle 10 decelerates and stops will be described with reference to FIGS. 3 and 4.

As illustrated in FIG. 3, in a case where the vehicle 10 is decelerated by applying the braking force to the front wheels 11 and the rear wheels 12, the vehicle 10 performs a pitching motion in a nose dive direction. In this case, a suspension 13F for a front wheel, which is provided to the front wheel 11, is contracted and a suspension 13R for a rear wheel, which is provided to the rear wheel 12, is extended by pitching moment due to deceleration. At the same time, due to geometry of each of the suspensions 13F and 13R, anti-dive force caused by applying the braking force to the front wheel 11 is generated at a front portion of a vehicle body 16, and anti-lift force caused by applying the braking force to the rear wheel 12 is generated at a rear portion of the vehicle body 16. The anti-dive force is force that displaces the front portion of the vehicle body 16 upward. The anti-lift force is force that displaces the rear portion of the vehicle body 16 downward. Furthermore, in a case where the vehicle 10 is decelerating, as indicated by white arrows in FIG. 3, friction force FF1 and friction force FF2 act on a ground contact surface between each of the wheels 11 and 12 and the road surface toward a down-hill side which is a rear side of the vehicle 10. Note that, the friction force FF1 acting on the ground contact surface between the front wheel 11 and the road surface is referred to as “first ground contact surface friction force FF1”, and the friction force FF2 acting on the ground contact surface between the rear wheel 12 and the road surface is referred to as “second ground contact surface friction force FF2”.

In the vehicle 10 illustrated in FIG. 3, a position of an end of the suspension 13F for a front wheel on the front wheel 11 side in a vehicle front-rear direction X is different from a position of an end of the suspension 13F for a front wheel on the vehicle body 16 side in the vehicle front-rear direction X, and the suspension 13F for a front wheel is provided such that the end of the suspension 13F for a front wheel on the vehicle body 16 side is set as a fulcrum. In the similar manner, a position of an end of the suspension 13R for a rear wheel on the rear wheel 12 side in the vehicle front-rear direction X is different from a position of an end of the suspension 13R for a rear wheel on the vehicle body 16 side in the vehicle front-rear direction X, and the suspension 13R for a rear wheel is provided such that the end of the suspension 13R for a rear wheel on the vehicle body 16 side is set as a fulcrum. Therefore, when the suspension 13F for a front wheel is displaced in a vertical direction such that the suspension 13F for a front wheel is contracted as described above, the position of the front wheel 11 in the vehicle front-rear direction X is different from a reference position of the front wheel 11. The reference position of the front wheel 11 is a position of the front wheel 11 in the vehicle front-rear direction X when the suspension 13F for a front wheel is located at a position in the vertical direction in a stop reference state. Furthermore, when the suspension 13R for a rear wheel is displaced in the vertical direction such that the suspension 13R for a rear wheel is extended as described above, the position of the rear wheel 12 in the vehicle front-rear direction X is different from a reference position of the rear wheel 12. The reference position of the rear wheel 12 is a position of the rear wheel 12 in the vehicle front-rear direction X when the suspension 13R for a rear wheel is located at a position in the vertical direction in the stop reference state.

The stop reference state is, for example, a state in which when the vehicle 10 is currently stopped on the road surface on which the vehicle 10 is positioned, force that is not generated during the stop is not applied. That is, the stop reference state when the vehicle 10 is stopped on the up-hill road having an inclination a corresponds to, for example, a state in which the vehicle 10 is placed on a horizontal plate, sufficient braking force is applied to the vehicle 10, one side of the plate in the front-rear direction is lifted in this state, and the inclination of the vehicle 10 in a front-rear direction is the inclination a. Furthermore, the stop reference state when the vehicle 10 is stopped on the up-hill road having the inclination a corresponds to a state in which the vehicle 10 is stopped by instantaneously increasing the braking force to a magnitude sufficient to maintain the state in which the vehicle 10 is stopped at a time point when a vehicle body speed VS becomes “0 (zero)” by deceleration due to gravity by causing the vehicle 10 to move forward on the up-hill road having the inclination a by inertia without applying both the braking force and the drive force.

When the position of at least one of the front wheel 11 and the rear wheel 12 in the vehicle front-rear direction X is displaced from the reference position of the wheel, a wheel base WBL of the vehicle is different from a reference wheel base WBLB. The reference wheel base WBLB is a wheel base in a case where the front wheel 11 is located at the reference position of the front wheel 11 and the rear wheel 12 is located at the reference position of the rear wheel 12. Note that, a form of each of the suspensions 13F and 13R illustrated in FIG. 3 is an example, and other forms of the suspensions may be adopted as the suspensions 13F and 13R as long as the suspensions are displaced in the vertical direction by the braking and a position of the wheel in the vehicle front-rear direction X changes from the reference position at the time of the braking.

In a case where the vehicle 10 is stopped on the up-hill road by applying the braking force to each of the wheels 11 and 12, the gravity applied to the vehicle 10 acts on the vehicle 10 as force causing the vehicle 10 to slide down. Therefore, in a case where the vehicle 10 is stopped on the up-hill road, as indicated by white arrows in FIG. 3, the ground contact surface friction force FF1 and the ground contact surface friction force FF2 act on the ground contact surface between each of the wheels 11 and 12 and the road surface toward the up-hill side which is a front side of the vehicle 10. That is, the directions of the ground contact surface friction force FF1 and the ground contact surface friction force FF2 change before and after the vehicle 10 is stopped.

Furthermore, in a case where the braking force is continued to be applied to the front wheel 11 even after the vehicle 10 is stopped, the front wheel 11 is in a locked state in which a rotation is restricted due to the front wheel braking force BPF. Accordingly, the displacement of the front wheel 11, which returns the position of the front wheel 11 in the vehicle front-rear direction X to the reference position, is regulated by an influence of the first ground contact surface friction force FF1 between the front wheel 11 and the road surface, and the front wheel braking force BPF. That is, the operation of the suspension 13F for a front wheel, which returns the position of the suspension 13F for a front wheel in the vertical direction to the position in the vertical direction in the stop reference state, is regulated. In the similar manner, in a case where the braking force is continued to be applied to the rear wheel 12 even after the vehicle 10 is stopped, the rear wheel 12 is in a locked state in which a rotation is restricted due to the rear wheel braking force BPR. Accordingly, the displacement of the rear wheel 12, which returns the position of the rear wheel 12 in the vehicle front-rear direction X to the reference position, is regulated by an influence of the second ground contact surface friction force FF2 between the rear wheel 12 and the road surface, and the rear wheel braking force BPR. That is, the operation of the suspension 13R for a rear wheel, which returns the position of the suspension 13R for a rear wheel in the vertical direction to the position in the vertical direction in the stop reference state, is regulated. The positions of the suspensions 13F and 13R in the vertical direction are the positions of the wheels 11 and 12 in the vertical direction with respect to the vehicle body 16, the positions being in accordance with the contraction or the extension of the suspensions 13F and 13R.

As illustrated in FIG. 1, the vehicle 10 is provided with various sensors. Examples of the sensor include a wheel speed sensor 101 and a front-rear acceleration sensor 102. The wheel speed sensor 101 is provided to each of the wheels 11 and 12. Then, the wheel speed sensor 101 detects a wheel speed VW of the corresponding wheels 11 and 12, and outputs a signal corresponding to the detected wheel speed VW as a detection signal. The front-rear acceleration sensor 102 detects front-rear acceleration GX which is acceleration in the vehicle front-rear direction X, and outputs a signal corresponding to the detected front-rear acceleration GX as a detection signal.

The detection signal from the wheel speed sensor 101 and the detection signal from the front-rear acceleration sensor 102 are input to the orientation control device 40. In the orientation control device 40, the vehicle body speed VS of the vehicle 10 is derived based on the wheel speeds VW of the wheels 11 and 12 based on the detection signal from each wheel speed sensor 101. Furthermore, in the orientation control device 40, a value obtained by time-differentiating the vehicle body speed VS is derived as vehicle body acceleration DVS of the vehicle.

The orientation control device 40 includes a slope road determination unit 41, an orientation control unit 42, a braking increase instruction unit 43, and a drive decrease instruction unit 44 as functional units that adjust a vehicle orientation when the vehicle 10 is stopped on a slope road.

The slope road determination unit 41 determines whether or not the road surface on which the vehicle 10 is stopped is the up-hill road. That is, when the vehicle 10 is stopped, the slope road determination unit 41 derives a road surface gradient θ which is a gradient of the road surface, and performs the determination based on the road surface gradient θ. For example, the slope road determination unit 41 calculates a value obtained by subtracting the vehicle body acceleration DVS from the front-rear acceleration GX as the road surface gradient θ. In a case where the vehicle is stopped on the up-hill road, the front-rear acceleration GX is greater than the vehicle body acceleration DVS, and thus the road surface gradient θ has a positive value. Therefore, the slope road determination unit 41 determines that the road surface is an up-hill road when the road surface gradient θ is equal to or greater than an up-hill road determination value θTh1. On the other hand, the slope road determination unit 41 does not determine that the road surface is an up-hill road when the road surface gradient θ is less than the up-hill road determination value θTh1.

The orientation control unit 42 performs orientation control when the vehicle 10 is stopped and the slope road determination unit 41 determines that the road surface is an up-hill road. The orientation control is control for instructing the braking device 20 to decrease the front wheel braking force BPF and the rear wheel braking force BPR, and instructing the drive device 30 to increase the drive force DP of the vehicle in a range in which the stop state of the vehicle 10 is maintained. The orientation control includes first braking decrease instruction processing, second braking decrease instruction processing, first drive increase instruction processing, and second drive increase instruction processing. A start timing of each processing and contents of each processing will be described later.

The braking increase instruction unit 43 performs braking increase control for instructing the braking device 20 to increase at least one of the front wheel braking force BPF and the rear wheel braking force BPR after the increase in the drive force DP of the vehicle due to the execution of the orientation control is ended. In the present embodiment, the braking increase instruction unit 43 instructs the braking device 20 to increase both the front wheel braking force BPF and the rear wheel braking force BPR in the braking increase control. The braking increase control includes first braking increase instruction processing and second braking increase instruction processing. A start timing of each processing and contents of each processing will be described later.

After the increase in the drive force DP of the vehicle due to the orientation control executed by the orientation control unit 42 is ended, the drive decrease instruction unit 44 executes drive decrease control for instructing the drive device 30 to decrease the drive force DP. The drive decrease control includes first drive decrease instruction processing and second drive decrease instruction processing. A start timing of each processing and contents of each processing will be described later.

Next, a processing routine executed by the orientation control device 40 will be described with reference to FIGS. 5 to 11. A series of processing routines illustrated in FIGS. 5 to 11 is repeatedly executed when the vehicle 10 is positioned on the up-hill road.

First, a main processing routine illustrated in FIG. 5 will be described.

In this processing routine, in Step S11, it is determined whether or not the vehicle 10 is stopped. For example, in a case where the vehicle body speed VS is “0 (zero)”, it is determined that the vehicle 10 is stopped, and in a case where the vehicle body speed VS is not “0 (zero)”, it is not determined that the vehicle 10 is stopped. In a case where it is not determined that the vehicle 10 is stopped (S11: NO), the processing proceeds to next Step S12. In Step S12, second instruction braking force BPTr2 at a current time point is set as second pre-stop braking force BP2b. The second instruction braking force BPTr2 is an instruction value of the braking force of the second wheel. In a case where the braking force BP of the vehicle 10 is adjusted by automatic braking, an instruction value of the braking force of the second wheel determined by the control device for automatic braking is set as the second instruction braking force BPTr2. On the other hand, in a case where the braking force BP of the vehicle 10 is adjusted by a braking operation of a driver, the current braking force of the second wheel is set as the second instruction braking force BPTr2. In the present embodiment, since the rear wheel 12 corresponds to the second wheel, any one of the current instruction value of the braking force of the rear wheel 12 and the current rear wheel braking force BPR is set as the second instruction braking force BPTr2. When the second pre-stop braking force BP2b is set, the processing proceeds to next Step S13.

In Step S13, a flag FLG1 during control and a control completion flag FLG2 are set to OFF. Furthermore, a stop counter CNTT and a step counter CNTS are reset to “0 (zero)”. The flag FLG1 during control is a flag that is set to ON when at least one of the orientation control, the braking increase control, and the drive decrease control is executed. The control completion flag FLG2 is a flag that is set to ON when all of the orientation control, the braking increase control, and the drive decrease control are completed. The stop counter CNTT is a counter that is updated to measure a start timing of the orientation control. The step counter CNTS is a counter that is updated when various processing to be described later are switched. After that, the processing routine is temporarily ended.

On the other hand, in Step S11, in a case where it is determined that the vehicle 10 is stopped (YES), the processing proceeds to next Step S14. In Step S14, it is determined whether or not the control completion flag FLG2 is set to ON. In a case where the control completion flag FLG2 is set to ON, all of the orientation control, the braking increase control, and the drive decrease control are completed. On the other hand, in a case where the control completion flag FLG2 is set to OFF, all of the orientation control, the braking increase control, and the drive decrease control are not executed yet, or at least one of the orientation control, the braking increase control, and the drive decrease control is being executed. In a case where the control completion flag FLG2 is set to ON (S14: YES), the processing routine is temporarily ended. On the other hand, in a case where the control completion flag FLG2 is set to OFF (S14: NO), the processing proceeds to next Step S15.

In Step S15, it is determined whether or not the flag FLG1 during control is set to ON. In a case where the flag FLG1 during control is set to ON, at least one of the orientation control, the braking increase control, and the drive decrease control is executed. On the other hand, in a case where the flag FLG1 during control is set to OFF, all of the orientation control, the braking increase control, and the drive decrease control are not executed yet. In a case where the flag FLG1 during control is set to ON (S15: YES), the processing proceeds to next Step S16.

In Step S16, it is determined whether or not there is a start instruction for the vehicle 10. In a case where the vehicle 10 is caused to travel by automatic driving, the start instruction is input to the orientation control device 40 from a control device for automatic driving. Therefore, in a case where the start instruction is input to the orientation control device 40, it is determined that there is the start instruction. On the other hand, in a case where the vehicle 10 is caused to travel by a manual operation of the driver, when it is detected that an accelerator operation is started, it is determined that there is the start instruction. When a sudden release of the braking operation is detected, it may be determined that there is the start instruction. In a case where it is not determined that there is the start instruction (S16: NO), the processing proceeds to Step S23 to be described later. That is, the control while the processing is executed is continued.

On the other hand, in a case where it is determined that there is the start instruction (S16: YES), the processing proceeds to Step S17 to be described later. In Step S17, “0 (zero)” is set as first instruction drive force DPTr1 which is an instruction value of the drive force input to the first wheel. In the present embodiment, since the front wheel 11 corresponds to the first wheel, the first instruction drive force DPTr1 is an instruction value of the drive force input to the front wheel 11. Then, the processing proceeds to Step S13 described above.

On the other hand, in Step S15, in a case where the flag FLG1 during control is set to OFF (NO), the processing proceeds to next Step S18. In Step S18, the stop counter CNTT is incremented by “one”. Subsequently, in Step S19, it is determined whether or not the stop counter CNTT updated in Step S18 is greater than a control start determination value CNTTTh. The control start determination value CNTTTh is set as a determination reference of whether or not to permit a start of the orientation control based on a magnitude of the stop counter CNTT corresponding to duration of the state in which the vehicle 10 is stopped. In a case where the stop counter CNTT is equal to or smaller than the control start determination value CNTTTh (S19: NO), the processing routine is temporarily ended. That is, the orientation control is not started yet.

On the other hand, in a case where the stop counter CNTT is greater than the control start determination value CNTTTh (S19: YES), the processing proceeds to next Step S20. In Step S20, the flag FLG1 during control is set to ON, and the step counter CNTS is incremented by “one”. Subsequently, in Step S21, stop holding force Fh is derived. The stop holding force Fh is force necessary for maintaining a state in which the vehicle 10 is stopped on the up-hill road. That is, the stop holding force Fh is force necessary for maintaining the stop state of the vehicle 10 against the action of gravity. The stop holding force Fh is derived based on the road surface gradient θ of the up-hill road on which the vehicle 10 is stopped. Specifically, the stop holding force Fh is larger as the road surface gradient θ is larger. In Step S22, first instruction braking force BPTr1 at a current time point is set as a first braking force previous value BP1a, the second instruction braking force BPTr2 at a current time point is set as a second braking force previous value BP2a, and the first instruction drive force DPTr1 at a current time point is set as a first drive force previous value DP1a. The first instruction braking force BPTr1 is an instruction value of the braking force of the first wheel. In the present embodiment, since the front wheel 11 corresponds to the first wheel, any one of the instruction value of the braking force of the front wheel 11 and the front wheel braking force BPF at a current time point is set as the first instruction braking force BPTr1. When the processing of Step S22 is completed, the processing proceeds to next Step S23.

In Step S23, processing for adjusting the braking and drive force is executed. The processing will be described later. Then, when the processing is executed, the processing routine is temporarily ended.

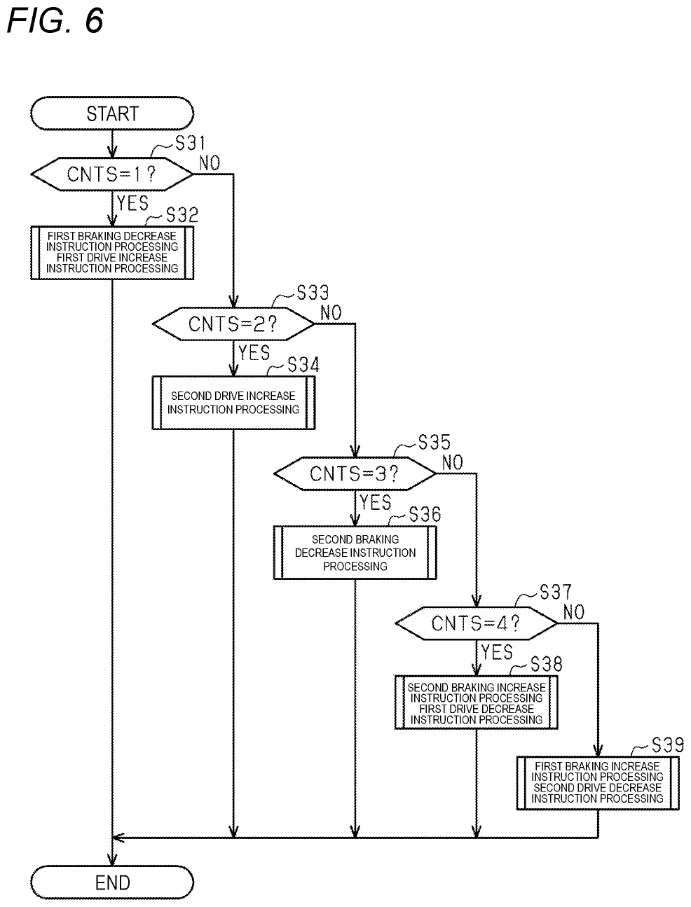

Next, the processing of Step S23 will be described with reference to FIG. 6.

In the processing routine, in Step S31, it is determined whether or not the step counter CNTS is “one”. In a case where it is determined that the step counter CNTS is “one” (S31: YES), the processing proceeds to next Step S32. In Step S32, the orientation control unit 42 executes the first braking decrease instruction processing and first drive increase instruction processing of the orientation control. The first braking decrease instruction processing is processing of instructing the braking control unit 22 to decrease the braking force of the first wheel. The first drive increase instruction processing is processing of instructing the drive control unit 32 to increase the drive force of the first wheel, that is, the drive force DP of the vehicle 10. The first drive increase instruction processing is one of drive increase instruction processing of instructing the drive device 30 to increase the drive force DP of the vehicle 10 in a range in which the stop state of the vehicle 10 is maintained. Specific contents of the first braking decrease instruction processing and the first drive increase instruction processing will be described later. When the first braking decrease instruction processing and the first drive increase instruction processing are executed, the processing routine is ended.

In Step S31, in a case where it is not determined that the step counter CNTS is “one” (NO), the processing proceeds to next Step S33. In Step S33, it is determined whether or not the step counter CNTS is “two”. In a case where it is determined that the step counter CNTS is “two” (S33: YES), the processing proceeds to next Step S34. In Step S34, the orientation control unit 42 executes the second drive increase instruction processing of the orientation control. The second drive increase instruction processing is processing of instructing the drive control unit 32 to increase the drive force of the first wheel, that is, the drive force DP of the vehicle 10. That is, the second drive increase instruction processing is also one of drive increase instruction processing. Specific contents of the second drive increase instruction processing will be described later. When the second drive increase instruction processing is executed, the processing routine is ended.

In Step S33, in a case where it is not determined that the step counter CNTS is “two” (NO), the processing proceeds to next Step S35. In Step S35, it is determined whether or not the step counter CNTS is “three”. In a case where it is determined that the step counter CNTS is “three” (S35: YES), the processing proceeds to next Step S36. In Step S36, the orientation control unit 42 executes the second braking decrease instruction processing of the orientation control. The second braking decrease instruction processing is processing of instructing the braking control unit 22 to decrease the braking force of the second wheel. Specific contents of the second braking decrease instruction processing will be described later. When the second braking decrease instruction processing is executed, the processing routine is ended.

In Step S35, in a case where it is not determined that the step counter CNTS is “three” (NO), the processing proceeds to next Step S37. In Step S37, it is determined whether or not the step counter CNTS is “four”. In a case where it is determined that the step counter CNTS is “four” (S37: YES), the processing proceeds to next Step S38. In step S38, the second braking increase instruction processing of the braking increase control is executed by the braking increase instruction unit 43, and the first drive decrease instruction processing of the drive decrease control is executed by the drive decrease instruction unit 44. The second braking increase instruction processing is processing of instructing the braking control unit 22 to increase the braking force of the second wheel. The first drive decrease instruction processing is processing of instructing the drive control unit 32 to decrease the drive force of the first wheel. Specific contents of the second braking increase instruction processing and the first drive decrease instruction processing will be described later. When the second braking increase instruction processing and the first drive decrease instruction processing are executed, the processing routine is ended.

In Step S37, in a case where it is not determined that the step counter CNTS is “four” (NO), since the step counter CNTS is “five”, the processing proceeds to next Step S39. In step S39, the first braking increase instruction processing of the braking increase control is executed by the braking increase instruction unit 43, and the second drive decrease instruction processing of the drive decrease control is executed by the drive decrease instruction unit 44. The first braking increase instruction processing is processing of instructing the braking control unit 22 to increase the braking force of the first wheel. The second drive decrease instruction processing is processing of instructing the drive control unit 32 to decrease the drive force of the first wheel. Specific contents of the first braking increase instruction processing and the second drive decrease instruction processing will be described later. When the first braking increase instruction processing and the second drive decrease instruction processing are executed, the processing routine is ended.

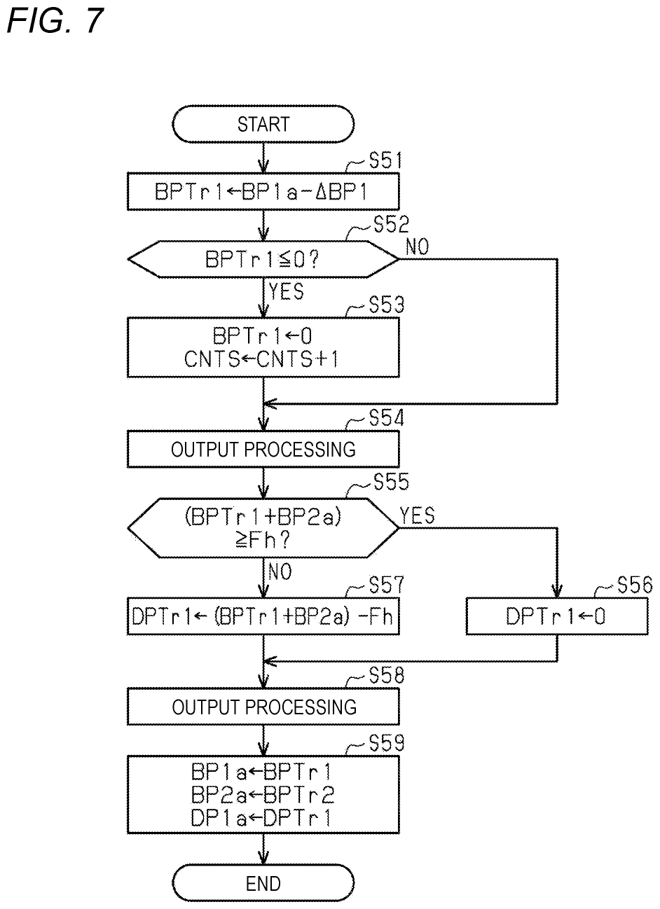

Next, the first braking decrease instruction processing and the first drive increase instruction processing in Step S32 described above will be described with reference to FIG. 7. The processing routine is executed by the orientation control unit 42.

In the processing routine, the first braking decrease instruction processing is executed. In the first braking decrease instruction processing, in Step S51 at the beginning, a value obtained by subtracting a first braking decrease amount ΔBP1 from the first braking force previous value BP1a described above is calculated as the latest first instruction braking force BPTr1. A positive value is set as the first braking decrease amount ΔBP1.

Subsequently, in Step S52, it is determined whether or not the first instruction braking force BPTr1 calculated in Step S51 is equal to or less than “0 (zero)”. In a case where the first instruction braking force BPTr1 is equal to or less than “0 (zero)” (S52: YES), the processing proceeds to next Step S53. In Step S53, “0 (zero)” is set as the first instruction braking force BPTr1, and the step counter CNTS is incremented by “one”. That is, the step counter CNTS is “two”. Then, the processing proceeds to next Step S54. On the other hand, in Step S52, in a case where the first instruction braking force BPTr1 is greater than “0 (zero)” (NO), the processing proceeds to next Step S54. That is, the step counter CNTS is held as “one”.

In Step S54, output processing of outputting the first instruction braking force BPTr1 and the second instruction braking force BPTr2 to the braking device 20 is executed. While the processing routine is executed repeatedly, the first instruction braking force BPTr1 output to the braking device 20 continues to decrease. Therefore, the outputting of the first instruction braking force BPTr1 to the braking device 20 through the execution of the processing routine corresponds to instructing the braking device 20 to decrease the braking force of the first wheel. Then, the processing to be executed is shifted from the first braking decrease instruction processing to the first drive increase instruction processing.

Note that, when the first instruction braking force BPTr1 and the second instruction braking force BPTr2 are input by executing the output processing, the braking control unit 22 controls the braking actuator 21 such that the braking force of the first wheel follows the first instruction braking force BPTr1 and the braking force of the second wheel follows the second instruction braking force BPTr2. In the first braking decrease instruction processing, the first instruction braking force BPTr1 is decreased and the second instruction braking force BPTr2 is held. Therefore, when an instruction based on the execution of the first braking decrease instruction processing is input to the braking control unit 22, the braking force of the first wheel can be decreased at a speed corresponding to the first braking decrease amount ΔBP1 while maintaining the braking force of the second wheel.

In the first drive increase instruction processing, in Step S55 at the beginning, it is determined whether or not the sum of the first instruction braking force BPTr1 and the second braking force previous value BP2a is equal to or greater than the stop holding force Fh. In a case where the sum thereof is equal to or greater than the stop holding force Fh, the stop state of the vehicle 10 can be held by making the braking force of the first wheel equal to the first instruction braking force BPTr1. On the other hand, in a case where the sum thereof is less than the stop holding force Fh, there is a possibility that the stop state of the vehicle 10 cannot be held by making the braking force of the first wheel equal to the first instruction braking force BPTr1.

In a case where the sum of the first instruction braking force BPTr1 and the second braking force previous value BP2a is equal to or greater than the stop holding force Fh (S55: YES), the processing proceeds to next Step S56. In Step S56, “0 (zero)” is set as the first instruction drive force DPTr1. Then, the processing proceeds to Step S58 to be described later. On the other hand, in a case where the sum thereof is less than the stop holding force Fh (S55: NO), the processing proceeds to next Step S57. In Step S57, a value obtained by subtracting the stop holding force Fh from the sum thereof is calculated as the first instruction drive force DPTr1. When the processing routine is repeatedly executed, since the first instruction braking force BPTr1 is decreased, the sum of the first instruction braking force BPTr1 and the second braking force previous value BP2a gradually decreases. Therefore, in the first drive increase instruction processing, the first instruction drive force DPTr1 is increased at a speed corresponding to a decrease speed of the first instruction braking force BPTr1. Then, the processing proceeds to next Step S58.

In Step S58, output processing of outputting the first instruction drive force DPTr1 to the drive device 30 is executed. While the processing routine is executed repeatedly, the first instruction drive force DPTr1 output to the drive device 30 continues to increase. Therefore, the outputting of the first instruction drive force DPTr1 to the drive device 30 through the execution of the processing routine corresponds to instructing the drive device 30 to increase the drive force DP of the vehicle 10.

Note that, when the first instruction drive force DPTr1 is input by executing the output processing, the drive control unit 32 controls the power unit 31 such that the drive force DP follows the first instruction drive force DPTr1. Accordingly, the drive force DP of the vehicle 10 can be increased in a range in which the stop state of the vehicle 10 can be maintained.

When the output processing is executed, the processing proceeds to next Step S59. In Step S59, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Note that, in a case where the processing routine is ended in a state in which the step counter CNTS is “one”, the first braking decrease instruction processing and the first drive increase instruction processing are respectively continued. On the other hand, in a case where the processing routine is ended in a state in which the step counter CNTS is “two”, the first braking decrease instruction processing and the first drive increase instruction processing are respectively ended.

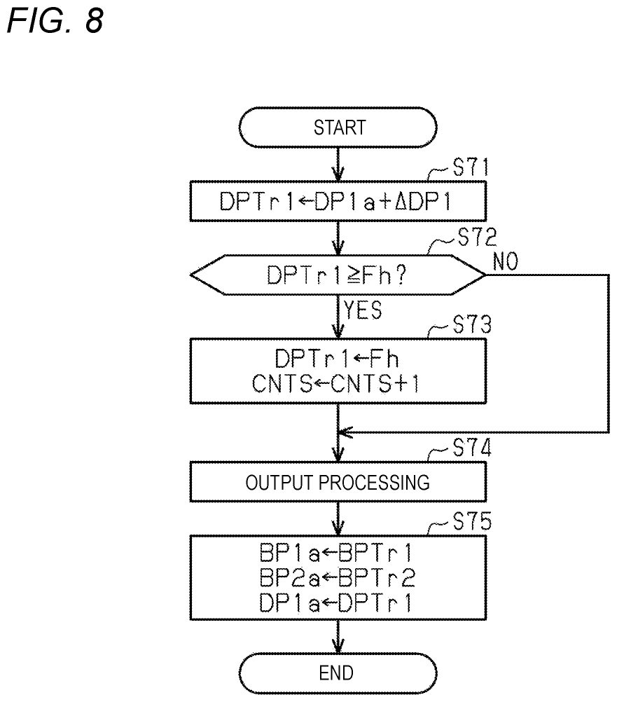

Next, the second drive increase instruction processing of Step S34 described above will be described with reference to FIG. 8. The processing routine is executed by the orientation control unit 42.

In the processing routine, in Step S71, the sum of the first drive force previous value DP1a and first drive increase amount ΔDP1 is calculated as the latest first instruction drive force DPTr1. A positive value derived from specifications of the power unit 31 is set as the first drive increase amount ΔDP1. Subsequently, in Step S72, it is determined whether or not the first instruction drive force DPTr1 calculated in Step S71 is equal to or greater than the stop holding force Fh described above. In a case where the first instruction drive force DPTr1 is equal to or greater than the stop holding force Fh, there is a possibility that the vehicle 10 is started when the braking force BP of the vehicle 10 becomes “0 (zero)”. Then, in a case where the first instruction drive force DPTr1 is equal to or greater than the stop holding force Fh (S72: YES), the processing proceeds to next Step S73. In Step S73, the stop holding force Fh is set as the first instruction drive force DPTr1, and the step counter CNTS is incremented by “one”. That is, the step counter CNTS is “three”. Then, the processing proceeds to next Step S74.

On the other hand, in Step S72, in a case where the first instruction drive force DPTr1 is less than the stop holding force Fh (NO), the processing proceeds to next Step S74. That is, the step counter CNTS is held as “two”.

In Step S74, output processing of outputting the first instruction drive force DPTr1 to the drive device 30 is executed. While the processing routine is executed repeatedly, the first instruction drive force DPTr1 output to the drive device 30 continues to increase. Therefore, the outputting of the first instruction drive force DPTr1 to the drive device 30 through the execution of the processing routine corresponds to instructing the drive device 30 to increase the drive force DP of the vehicle 10.

Note that, when the first instruction drive force DPTr1 is input by executing the output processing, the drive control unit 32 controls the power unit 31 such that the drive force DP follows the first instruction drive force DPTr1. Accordingly, the drive force DP of the vehicle can be increased at a speed corresponding to the first drive increase amount ΔDP1.

When the output processing is executed, the processing proceeds to next Step S75. In Step S75, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Note that, in a case where the processing routine is ended in a state in which the step counter CNTS is “two”, the second drive increase instruction processing is continued. On the other hand, in a case where the processing routine is ended in a state in which the step counter CNTS is “three”, the second drive increase instruction processing is ended.

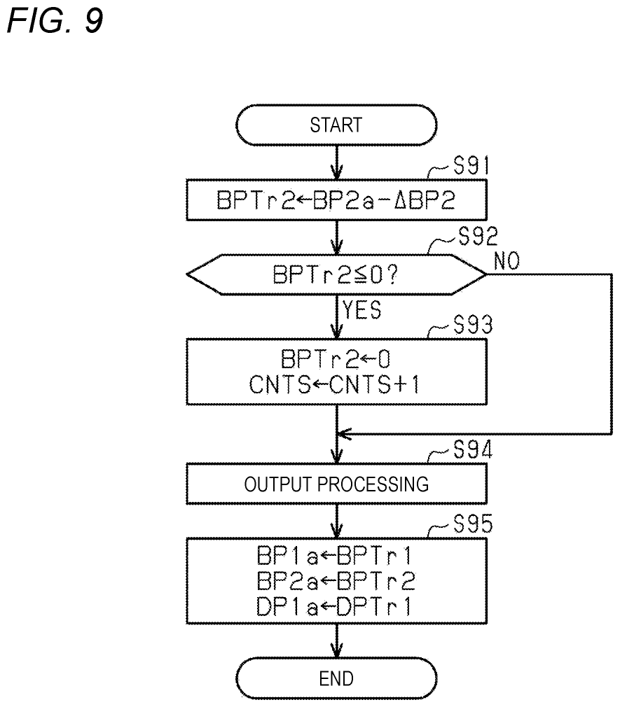

Next, the second braking decrease instruction processing of Step S36 described above will be described with reference to FIG. 9. The processing routine is executed by the orientation control unit 42.

In the processing routine, in Step S91, a value obtained by subtracting a second braking decrease amount ΔBP2 from the second braking force previous value BP2a described above is calculated as the latest second instruction braking force BPTr2. A positive value is set as the second braking decrease amount ΔBP2. The second braking decrease amount ΔBP2 may be the same as the first braking decrease amount ΔBP1, may be smaller than the first braking decrease amount ΔBP1, or may be greater than the first braking decrease amount ΔBP1. Subsequently, in Step S92, it is determined whether or not the second instruction braking force BPTr2 calculated in Step S91 is equal to or less than “0 (zero)”. In a case where the second instruction braking force BPTr2 is equal to or less than “0 (zero)” (S92: YES), the processing proceeds to next Step S93. In Step S93, “0 (zero)” is set as the second instruction braking force BPTr2, and the step counter CNTS is incremented by “one”. That is, the step counter CNTS is “four”. Then, the processing proceeds to next Step S94. On the other hand, in Step S92, in a case where the second instruction braking force BPTr2 is greater than “0 (zero)” (NO), the processing proceeds to next Step S94. That is, the step counter CNTS is held as “three”.

In Step S94, output processing of outputting the first instruction braking force BPTr1 and the second instruction braking force BPTr2 to the braking device 20 and outputting the first instruction drive force DPTr1 to the drive device 30 is executed. While the processing routine is executed repeatedly, the second instruction braking force BPTr2 output to the braking device 20 continues to decrease. Therefore, the outputting of the second instruction braking force BPTr2 to the braking device 20 through the execution of the processing routine corresponds to instructing the braking device 20 to decrease the braking force of the second wheel.

Note that, when the first instruction braking force BPTr1 and the second instruction braking force BPTr2 are input by executing the output processing, the braking control unit 22 controls the braking actuator 21 such that the braking force of the first wheel follows the first instruction braking force BPTr1 and the braking force of the second wheel follows the second instruction braking force BPTr2. In the second braking decrease instruction processing, the first instruction braking force BPTr1 is held and the second instruction braking force BPTr2 is decreased. Therefore, when an instruction based on the execution of the second braking decrease instruction processing is input to the braking control unit 22, the braking force of the second wheel can be decreased at a speed corresponding to the second braking decrease amount ΔBP2 while maintaining the braking force of the first wheel. Furthermore, the first instruction drive force DPTr1 is not changed in the execution of the second braking decrease instruction processing. Therefore, the drive force DP of the vehicle 10 is held by inputting an instruction based on the execution of the second braking decrease instruction processing to the drive control unit 32.

When the output processing is executed, the processing proceeds to next Step S95. In Step S95, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Note that, in a case where the processing routine is ended in a state in which the step counter CNTS is “three”, the second braking decrease instruction processing is continued. On the other hand, in a case where the processing routine is ended in a state in which the step counter CNTS is “four”, the second braking decrease instruction processing is ended.

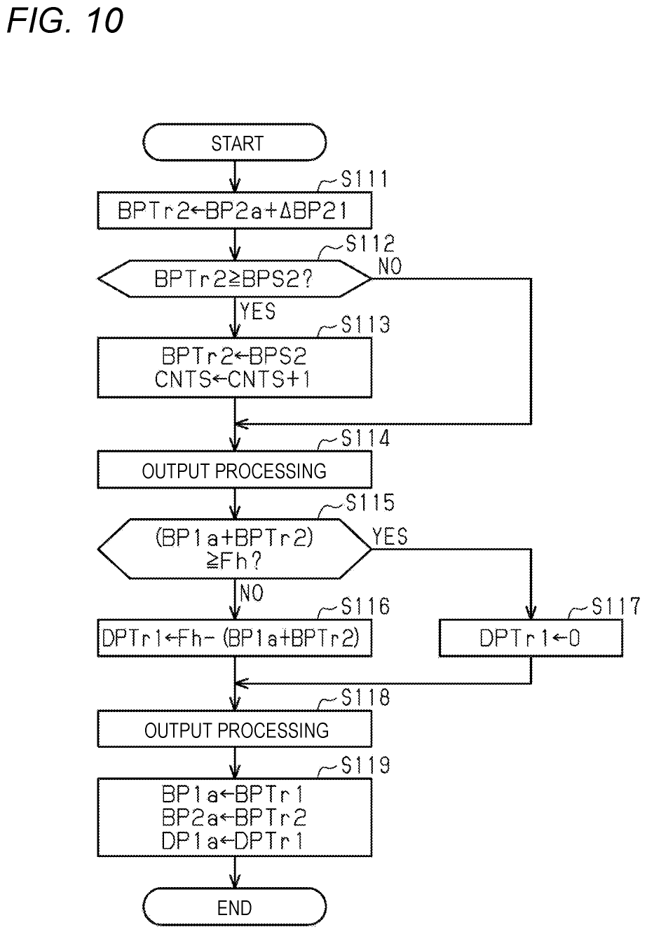

Next, the second braking increase instruction processing and the first drive decrease instruction processing in Step S38 described above will be described with reference to FIG. 10.

In the processing routine, the second braking increase instruction processing is executed by the braking increase instruction unit 43. In the second braking increase instruction processing, in Step S111 at the beginning, the sum of the second braking force previous value BP2a and a second braking increase amount ΔBP21 is calculated as the latest second instruction braking force BPTr2. A positive value is set as the second braking increase amount ΔBP21. Subsequently, in Step S112, it is determined whether or not the second instruction braking force BPTr2 calculated in Step S111 is equal to or greater than a second target braking force BPS2. As the second target braking force BPS2, for example, a value slightly greater than the braking force of the second wheel at a time point of starting the orientation control or the braking force is set. Alternatively, as the second target braking force BPS2, the braking force according to the braking operation by the driver at a current time point, or the braking force set by the control device for automatic braking may be set. In a case where the second instruction braking force BPTr2 is equal to or greater than the second target braking force BPS2 (S112: YES), the processing proceeds to next Step S113. In Step S113, the second target braking force BPS2 is set as the second instruction braking force BPTr2, and the step counter CNTS is incremented by “one”. That is, the step counter CNTS is “five”. Then, the processing proceeds to next Step S114.

On the other hand, in Step S112, in a case where the second instruction braking force BPTr2 is less than the second target braking force BPS2 (NO), the processing proceeds to next Step S114. That is, the step counter CNTS is held as “four”.

In Step S114, output processing of outputting the first instruction braking force BPTr1 and the second instruction braking force BPTr2 to the braking device 20 is executed. While the processing routine is executed repeatedly, the second instruction braking force BPTr2 output to the braking device 20 continues to increase. Therefore, the outputting of the second instruction braking force BPTr2 to the braking device 20 through the execution of the processing routine corresponds to instructing the braking device 20 to increase the braking force of the second wheel. Then, the processing to be executed is shifted from the second braking increase instruction processing to the first drive decrease instruction processing.

Note that, when the first instruction braking force BPTr1 and the second instruction braking force BPTr2 are input by executing the output processing, the braking control unit 22 controls the braking actuator 21 such that the braking force of the first wheel follows the first instruction braking force BPTr1 and the braking force of the second wheel follows the second instruction braking force BPTr2. In the second braking increase instruction processing, the first instruction braking force BPTr1 is held and the second instruction braking force BPTr2 is increased. Therefore, when an instruction based on the execution of the second braking increase instruction processing is input to the braking control unit 22, the braking force of the second wheel can be increased at a speed corresponding to the second braking increase amount ΔBP21 while maintaining the braking force of the first wheel.

The first drive decrease instruction processing is executed by the drive decrease instruction unit 44. In the first drive decrease instruction processing, in Step S115, it is determined whether or not the sum of the first braking force previous value BP1a and the second instruction braking force BPTr2 is equal to or greater than the stop holding force Fh. In a case where the sum thereof is less than the stop holding force Fh, there is a possibility that the vehicle 10 is started unless the drive force DP of the vehicle 10 is decreased. In a case where the sum thereof is less than the stop holding force Fh (S115: NO), the processing proceeds to next Step S116. In Step S116, a value obtained by subtracting the sum thereof from the stop holding force Fh is calculated as the first instruction drive force DPTr1. When the processing routine is repeatedly executed, since the second instruction braking force BPTr2 is increased, the sum of the first braking force previous value BP1a and the second instruction braking force BPTr2 is increased. As a result, the first instruction drive force DPTr1 is decreased at a speed corresponding to an increase speed of the second instruction braking force BPTr2. Then, the processing proceeds to Step S118 to be described later.

On the other hand, in Step S115, in a case where the sum of the first braking force previous value BP1a and the second instruction braking force BPTr2 is equal to or greater than the stop holding force Fh (YES), the processing proceeds to next Step S117. In Step S117, “0 (zero)” is set as the first instruction drive force DPTr1. Then, the processing proceeds to next Step S118.

In Step S118, output processing of outputting the first instruction drive force DPTr1 to the drive device 30 is executed. While the processing routine is executed repeatedly, the first instruction drive force DPTr1 output to the drive device 30 continues to decrease. Therefore, the outputting of the first instruction drive force DPTr1 to the drive device 30 through the execution of the processing routine corresponds to instructing the drive device 30 to decrease the drive force DP of the vehicle 10.

Note that, when the first instruction drive force DPTr1 is input by executing the output processing, the drive control unit 32 controls the power unit 31 such that the drive force DP of the vehicle 10 follows the first instruction drive force DPTr1. In the first drive decrease instruction processing, the first instruction drive force DPTr1 is decreased. Therefore, the drive force DP of the vehicle 10 is decreased by inputting an instruction based on the execution of the first drive decrease instruction processing to the drive control unit 32.

When the output processing is executed, the processing proceeds to next Step S119. In Step S119, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Note that, in a case where the processing routine is ended in a state in which the step counter CNTS is “four”, the second braking increase instruction processing and the first drive decrease instruction processing are respectively continued. On the other hand, in a case where the processing routine is ended in a state in which the step counter CNTS is “five”, the second braking increase instruction processing and the first drive decrease instruction processing are respectively ended.

Next, the first braking increase instruction processing and the second drive decrease instruction processing in Step S39 described above will be described with reference to FIG. 11.

In the processing routine, the first braking increase instruction processing is executed by the braking increase instruction unit 43. In the first braking increase instruction processing, in Step S131 at the beginning, the sum of the first braking force previous value BP1a and a first braking increase amount ΔBP11 is calculated as the first instruction braking force BPTr1. A positive value is set as the first braking increase amount ΔBP11.

Subsequently, in Step S132, it is determined whether or not the first instruction braking force BPTr1 calculated in Step S131 is equal to or greater than a first target braking force BPS1. As the first target braking force BPS1, for example, a value slightly greater than the braking force of the first wheel at a time point of starting the orientation control or the braking force is set. Alternatively, as the first target braking force BPS1, the braking force according to the braking operation by the driver at a current time point, or the braking force set by the control device for automatic braking may be set. In a case where the first instruction braking force BPTr1 is equal to or greater than the first target braking force BPS1 (S132: YES), the processing proceeds to next Step S133. On the other hand, in a case where the first instruction braking force BPTr1 is less than the first target braking force BPS1 (S132: NO), the processing proceeds to Step S134.

In Step S133, the first target braking force BPS1 is set as the first instruction braking force BPTr1, and the step counter CNTS is set to “0 (zero)”. Furthermore, the control completion flag FLG2 is set to ON. That is, both the flags FLG1 and FLG2 are set to be ON. Then, the processing proceeds to next Step S134.

In Step S134, output processing of outputting the first instruction braking force BPTr1 and the second instruction braking force BPTr2 to the braking device 20 is executed. While the processing routine is executed repeatedly, the first instruction braking force BPTr1 output to the braking device 20 continues to increase. Therefore, the outputting of the first instruction braking force BPTr1 to the braking device 20 through the execution of the processing routine corresponds to instructing the braking device 20 to increase the braking force of the first wheel. Then, the processing to be executed is shifted from the first braking increase instruction processing to the second drive decrease instruction processing.

Note that, when the first instruction braking force BPTr1 and the second instruction braking force BPTr2 are input by executing the output processing, the braking control unit 22 controls the braking actuator 21 such that the braking force of the first wheel follows the first instruction braking force BPTr1 and the braking force of the second wheel follows the second instruction braking force BPTr2. In the first braking increase instruction processing, the second instruction braking force BPTr2 is held and the first instruction braking force BPTr1 is increased. Therefore, when an instruction based on the execution of the first braking increase instruction processing is input to the braking control unit 22, the braking force of the first wheel can be increased at a speed corresponding to the first braking increase amount ΔBP11 described above while maintaining the braking force of the second wheel.

The second drive decrease instruction processing is executed by the drive decrease instruction unit 44. In the second drive decrease instruction processing, in Step S135 at the beginning, it is determined whether or not the sum of the second braking force previous value BP2a and the first instruction braking force BPTr1 is equal to or greater than the stop holding force Fh. In a case where the sum thereof is less than the stop holding force Fh, there is a possibility that the vehicle 10 is started unless the drive force DP of the vehicle 10 is decreased. In a case where the sum thereof is less than the stop holding force Fh (S135: NO), the processing proceeds to next Step S136. In Step S136, a value obtained by subtracting the sum thereof from the stop holding force Fh is calculated as the first instruction drive force DPTr1. When the processing routine is repeatedly executed, since the first instruction braking force BPTr1 is increased, the sum of the second braking force previous value BP2a and the first instruction braking force BPTr1 is increased. As a result, the first instruction drive force DPTr1 is decreased at a speed corresponding to an increase speed of the first instruction braking force BPTr1. Then, the processing proceeds to Step S138 to be described later.

On the other hand, in Step S135, in a case where the sum of the second braking force previous value BP2a and the first instruction braking force BPTr1 is equal to or greater than the stop holding force Fh (YES), the processing proceeds to next Step S137. In Step S137, “0 (zero)” is set as the first instruction drive force DPTr1. Then, the processing proceeds to next Step S138.

In Step S138, output processing of outputting the first instruction drive force DPTr1 to the drive device 30 is executed. While the processing routine is executed repeatedly, the first instruction drive force DPTr1 output to the drive device 30 continues to decrease. Therefore, the outputting of the first instruction drive force DPTr1 to the drive device 30 through the execution of the processing routine corresponds to instructing the drive device 30 to decrease the drive force DP of the vehicle 10.

Note that, when the first instruction drive force DPTr1 is input by executing the output processing, the drive control unit 32 controls the power unit 31 such that the drive force DP of the vehicle 10 follows the first instruction drive force DPTr1. In the second drive decrease instruction processing, the first instruction drive force DPTr1 is decreased. Therefore, the drive force DP of the vehicle 10 is decreased by inputting an instruction based on the execution of the second drive decrease instruction processing to the drive control unit 32.

When the output processing is executed, the processing proceeds to next Step S139. In Step S139, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Note that, in a case where the processing routine is ended in a state in which the control completion flag FLG2 is set to OFF, the first braking increase instruction processing and the second drive decrease instruction processing are respectively continued. On the other hand, in a case where the processing routine is ended in a state in which the flags FLG1 and FLG2 are set to ON, the first braking increase instruction processing and the second drive decrease instruction processing are respectively ended.

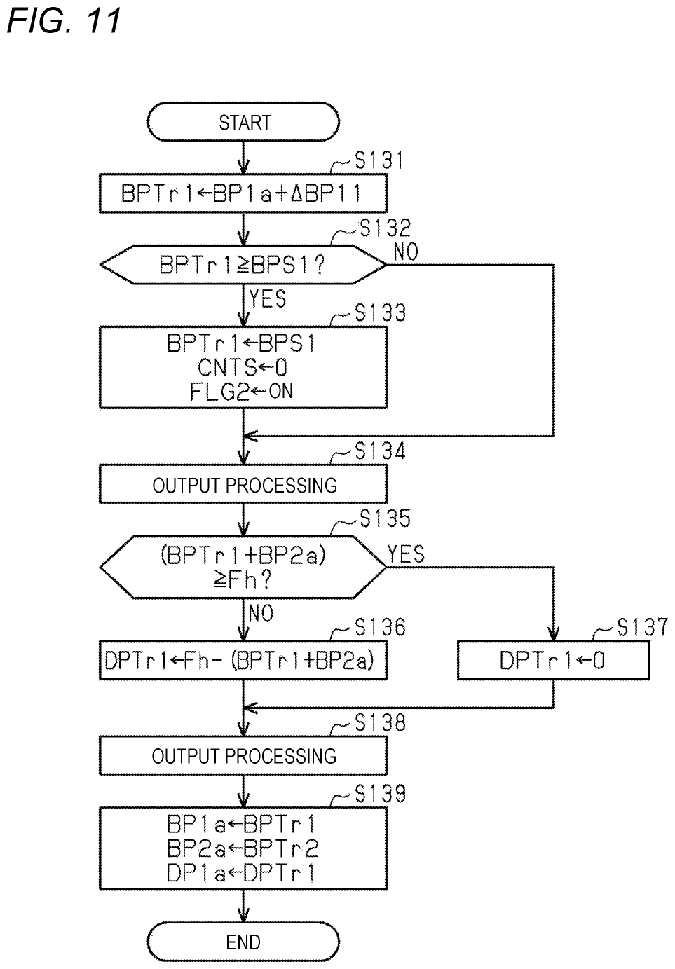

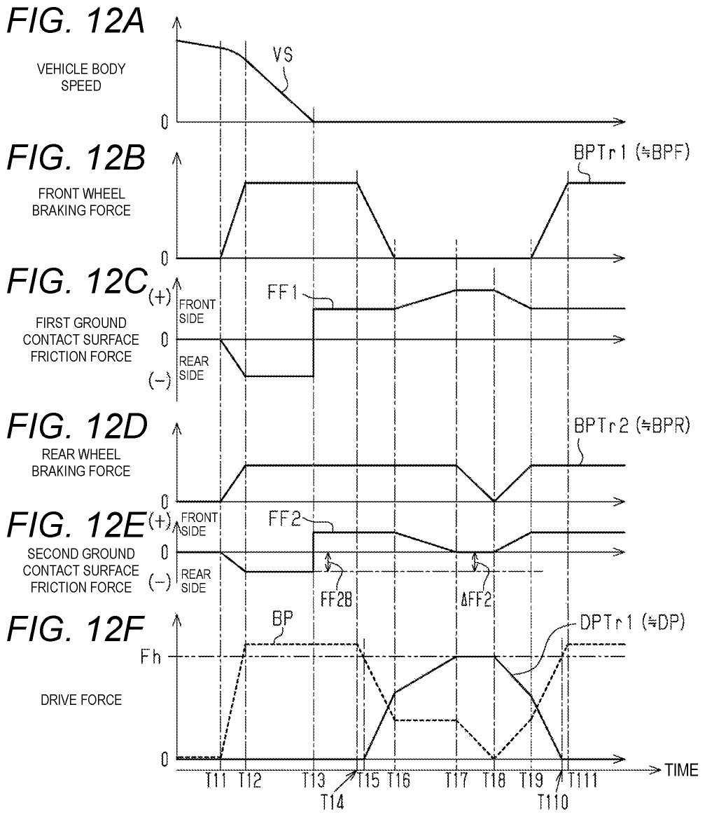

Next, actions and effects of the present embodiment will be described with reference to FIG. 12. As a premise, it is assumed that the vehicle 10 is positioned on the up-hill road.

As illustrated in FIGS. 12A, 12B, 12C, 12D, 12E, and 12F, the braking force BP is applied to the vehicle at timing T11 at which the vehicle 10 is traveling on the up-hill road. At this time, in a period from the timing T11 to timing T12, the front wheel braking force BPF which is the braking force of the first wheel is increased, and the rear wheel braking force BPR which is the braking force of the second wheel is increased. After the timing T12, the front wheel braking force BPF and the rear wheel braking force BPR are respectively held.

When the braking force is applied to the front wheel 11 which is the first wheel in this manner, the first ground contact surface friction force FF1 acts on a ground contact surface between the front wheel 11 and the road surface toward the down-hill side which is the rear side of the vehicle 10. The first ground contact surface friction force FF1 increases as the front wheel braking force BPF increases. In the similar manner, when the braking force is applied to the rear wheel 12 which is the second wheel, the second ground contact surface friction force FF2 acts on a ground contact surface between the rear wheel 12 and the road surface toward the down-hill side which is the rear side of the vehicle 10. The second ground contact surface friction force FF2 increases as the rear wheel braking force BPR increases. When the vehicle 10 is stopped at timing T13 by applying the braking force BP, the positive and negative of the first ground contact surface friction force FF1 and the second ground contact surface friction force FF2 are reversed. That is, the first ground contact surface friction force FF1 acts on the ground contact surface between the front wheel 11 and the road surface toward the up-hill side which is the front side of the vehicle 10, and the second ground contact surface friction force FF2 acts on the ground contact surface between the rear wheel 12 and the road surface toward the up-hill side which is the front side of the vehicle 10.

Furthermore, in a case where the vehicle 10 is decelerated by applying the braking force BP, the vehicle 10 performs a pitching motion in a nose dive direction. Then, the suspension 13F for a front wheel is contracted, the suspension 13R for a rear wheel is extended. At the same time, due to geometry of each of the suspensions 13F and 13R, an anti-dive force caused by the front wheel braking force BPF is generated at a front portion of the vehicle body 16, and an anti-lift force caused by the rear wheel braking force BPR is generated at a rear portion of the vehicle body 16. According to this, a position of the front wheel 11 in the vehicle front-rear direction X is changed from the reference position of the front wheel 11, and a position of the rear wheel 12 in the vehicle front-rear direction X is changed from the reference position of the rear wheel 12. As a result, the wheel base WBL of the vehicle 10 is changed from the reference wheel base WBLB.

In the example illustrated in FIG. 12, the front wheel braking force BPF and the rear wheel braking force BPR are respectively held even when the vehicle 10 is stopped at the timing T13. As a result, the wheels 11 and 12 are in a locked state in which the rotation is regulated, and a state in which a position of each of the suspensions 13F and 13R in the vertical direction is displaced is maintained. According to this, a state is maintained in which the position of the front wheel 11 in the vehicle front-rear direction X is different from the reference position of the front wheel 11, and the position of the rear wheel 12 in the vehicle front-rear direction X is different from the reference position of the rear wheel 12. That is, a state is maintained in which the wheel base WBL of the vehicle 10 is different from the reference wheel base WBLB.

In the present embodiment, the orientation control is started from timing T14 when the vehicle 10 is stopped. When the orientation control is executed, the front wheel braking force BPF and the rear wheel braking force BPR are decreased. Furthermore, the drive force DP of the vehicle is increased such that the stop state of the vehicle 10 is maintained even when the braking force BP of the vehicle is decreased in this manner. When the front wheel braking force BPF is decreased by executing the orientation control, since the rotation of the front wheel 11 is permitted, the position of the front wheel 11 in the vehicle front-rear direction X can be returned to the reference position of the front wheel 11, that is, the state of the suspension 13F for a front wheel can be returned to the original state. Furthermore, when the rear wheel braking force BPR is decreased by executing the orientation control, since the rotation of the rear wheel 12 is permitted, the position of the rear wheel 12 in the vehicle front-rear direction X can be returned to the reference position of the rear wheel 12, that is, the state of the suspension 13R for a rear wheel can be returned to the original state. That is, while the vehicle 10 is stopped, the wheel base WBL of the vehicle 10 can be returned to the reference wheel base WBLB. Therefore, when the braking of the vehicle 10 is released to start the vehicle 10 after that, it is possible to suppress a sudden change in the orientation of the vehicle 10, which occurs due to the change in the wheel base WBL. Accordingly, it is possible to prevent the occupant of the vehicle 10 from feeling discomfort when the vehicle is started.

Specifically, the first braking decrease instruction processing of the orientation control is started from the timing T14. When the first braking decrease instruction processing is executed, since the first instruction braking force BPTr1 is decreased, the front wheel braking force BPF is decreased by driving of the braking actuator 21. Since the first instruction braking force BPTr1 becomes “zero” at timing T16, the first braking decrease instruction processing is ended. In the present embodiment, when the front wheel braking force BPF is decreased in a period from the timing T14 to the timing T16, the rotation of the front wheel 11 is permitted, and the position of the front wheel 11 in the vehicle front-rear direction X is returned to the reference position of the front wheel 11.

While the first braking decrease instruction processing is executed, the braking force BP of the vehicle is decreased. Then, since the sum of the first instruction braking force BPTr1 and the second braking force previous value BP2a is less than the stop holding force Fh at timing T15 when the first braking decrease instruction processing is executed, the increase in the first instruction drive force DPTr1 is started by executing the first drive increase instruction processing of the orientation control. In this way, the drive force DP of the vehicle 10 is increased by driving of the power unit 31 according to the increase in the first instruction drive force DPTr1. That is, switching from the front wheel braking force BPF to the drive force DP of the vehicle 10 is performed by also executing the first drive increase instruction processing during the execution of the first braking decrease instruction processing. According to this, even when the braking force BP of the vehicle 10 is decreased due to the execution of the first braking decrease instruction processing, a state in which the vehicle 10 is stopped can be maintained.

When the first braking decrease instruction processing is ended at the timing T16, the first drive increase instruction processing is ended, and the second drive increase instruction processing is started as drive increase instruction processing. Therefore, since the first instruction drive force DPTr1 is increased even after the timing T16, the drive force DP of the vehicle 10 is increased. Then, since the first instruction drive force DPTr1 reaches the stop holding force Fh at timing T17, the second drive increase instruction processing is ended. That is, the increase in the drive force DP of the vehicle 10 is ended. At this point, even when the braking of the vehicle 10 is released, the stop state of the vehicle 10 can be maintained by the drive force DP.

In this way, from the timing T17, the second braking decrease instruction processing of the orientation control is started in a state in which the first instruction drive force DPTr1, that is, the drive force DP of the vehicle 10 is held. When the second braking decrease instruction processing is executed, since the second instruction braking force BPTr2 is decreased, the rear wheel braking force BPR is decreased by the driving of the braking actuator 21. Since the second instruction braking force BPTr2 becomes “zero” at timing T18, the second braking decrease instruction processing is ended. In the present embodiment, when the rear wheel braking force BPR is decreased in a period from the timing T17 to the timing T18, the rotation of the rear wheel 12 is permitted, and the position of the rear wheel 12 in the vehicle front-rear direction X is returned to the reference position of the rear wheel 12. As a result, in the period from the timing T17 to the timing T18, the wheel base WBL of the vehicle is returned to the reference wheel base WBLB.

Note that, since the drive force DP of the vehicle 10 is increased after the timing T16 at which the braking of the front wheel 11 is released, propulsive force moving the vehicle 10 forward is applied to the vehicle 10. According to this, the sum of the drive force DP and the rear wheel braking force BPR becomes greater than the stop holding force Fh. In a case where the front wheel braking force BPF is greater than “0 (zero)”, the drive force DP is offset by the front wheel braking force BPF. Therefore, the sum of the excessive drive force which is a value obtained by subtracting the front wheel braking force BPF from the drive force DP and the rear wheel braking force BPR can be greater than the stop holding force Fh. In this case, since the front wheel braking force BPF is “0 (zero)”, the excessive drive force is equal to the drive force DP. Then, the second ground contact surface friction force FF2 acting on the rear wheel 12 is gradually decreased as the drive force DP, that is, the propulsive force is increased due to an increase in excessive drive force. This is because gravity moving the vehicle 10 toward the down-hill side is supported by the propulsive force. When the first instruction drive force DPTr1 is equal to the stop holding force Fh, that is, when the excessive drive force is equal to the stop holding force Fh, the second ground contact surface friction force FF2 is substantially “0 (zero)”.

Here, in a case where the second ground contact surface friction force FF2 obtained immediately before the vehicle 10 is stopped is a second ground contact surface action force reference value FF2B, the suspension 13R for a rear wheel is rapidly moved when the rear wheel 12 transits from a locked state to a rotating state as a deviation ΔFF2 between the second ground contact surface friction force FF2 and the second ground contact surface action force reference value FF2B when the position of the rear wheel 12 in the vehicle front-rear direction X is returned to the reference position of the rear wheel 12 is larger. That is, displacement speed of the rear wheel 12 when the position of the rear wheel 12 in the vehicle front-rear direction X is returned to the reference position of the rear wheel 12 is increased. At this time, there is a possibility that vibration and sound caused by a sudden movement of the suspension 13R for a rear wheel are generated.

In this point, in the present embodiment, the position of the rear wheel 12 in the vehicle front-rear direction X can be returned to the reference position of the rear wheel 12 after the second ground contact surface friction force FF2 becomes substantially “0 (zero)” as the drive force DP is increased. In a case where the rear wheel 12 is rotated in this manner, the friction force corresponding to the rear wheel braking force BPR changes from static friction to kinetic friction when the rear wheel 12 transits from the locked state to the rotating state. For example, in a case where a braking mechanism provided on the rear wheel 12 is a disk type braking mechanism, friction between the disk and a friction material changes from the static friction to the kinetic friction. Therefore, even when pressing force, which is force pressing the friction material to the disk, is smoothly decreased, the braking force is rapidly decreased at the moment when the friction changes from the static friction to the kinetic friction. At this time, as the deviation ΔFF2 described above is smaller, the force displacing the rear wheel 12 to the reference position of the rear wheel 12 becomes smaller at the time when the rear wheel 12 transits to the rotating state. As a result, by comparing with the case where the deviation ΔFF2 is large, it is possible to suppress the sudden movement of the suspension 13R for a rear wheel when the rear wheel 12 transits from the locked state to the rotating state and the friction force corresponding to the rear wheel braking force BPR changes from the static friction to the kinetic friction.

At the time of the braking, since the suspension 13R for a rear wheel is extended more than that in the stop reference state described above, the position of the rear wheel 12 in the vehicle front-rear direction X during the braking is disposed on a side on which the wheel base WBL is shortened with respect to the reference position of the rear wheel 12. Therefore, after the braking, the position of the rear wheel 12 in the vehicle front-rear direction X is on the way of returning from the position at which the wheel base WBL is shortened with respect to the reference position during the braking to the reference position of the rear wheel 12. Therefore, the force moving the rear wheel 12 rearward of the vehicle acts on the rear wheel 12. Moreover, in a case where the vehicle 10 is stopped on the up-hill road, the second ground contact surface friction force FF2 acts on the ground contact surface between the rear wheel 12 and the road surface toward the down-hill side which is the rear side of the vehicle. In this case, the second ground contact surface friction force FF2 acts on the rear wheel 12 as the force moving the rear wheel 12 rearward of the vehicle. That is, the force moving the rear wheel 12 rearward of the vehicle is further increased. Therefore, since the second ground contact surface friction force FF2 is decreased by increasing the drive force DP, the force rotating the rear wheel 12 in a direction of moving the rear wheel 12 rearward of the vehicle can be decreased at the time when the rear wheel 12 transits to the rotating state. As a result, by comparing with the case where the second ground contact surface friction force FF2 applied toward the down-hill side which is the rear side of the vehicle 10 is large, it is possible to suppress the sudden movement of the suspension 13R for a rear wheel when the rear wheel 12 transits from the locked state to the rotating state and the friction force corresponding to the rear wheel braking force BPR changes from the static friction to the kinetic friction.

By appropriately changing the second ground contact surface friction force FF2 with the drive force DP as described above, it is possible to gently change the orientation of the vehicle 10 according to the change in the wheel base WBL. Furthermore, it is possible to prevent vibration and sound caused by a sudden movement of the suspension 13R for a rear wheel from being generated.

Furthermore, in the present embodiment, the timing at which the position of the rear wheel 12 in the vehicle front-rear direction X is returned to the reference position of the rear wheel 12 is deviated from the timing at which the position of the front wheel 11 in the vehicle front-rear direction X is returned to the reference position of the front wheel 11. According to this, it is possible to suppress an increase in the change speed of the wheel base WBL by comparing with the case where the front wheel 11 and the rear wheel 12 are returned to the reference position substantially simultaneously. According to this, it is possible to make it difficult for the occupant of the vehicle 10 to notice the change in the orientation of the vehicle 10 caused by the change in the wheel base WBL during the stop of the vehicle 10.

When the second braking decrease instruction processing, that is, the orientation control is ended in this manner, the front wheel braking force BPF and the rear wheel braking force BPR are increased by the driving of the braking actuator 21 based on the execution of the braking increase control. Furthermore, the drive force DP of the vehicle 10 is decreased by the driving of the power unit 31 based on the execution of the drive increase control. According to this, since it is possible to prevent the drive force DP from being continuously applied to the vehicle 10 while the vehicle 10 is stopped, it is possible to suppress a decrease in energy efficiency of the vehicle.

In the present embodiment, the second braking increase instruction processing and the first drive decrease instruction processing are started from the timing T18. When the second braking increase instruction processing is executed, since the second instruction braking force BPTr2 is increased, the rear wheel braking force BPR is increased by the driving of the braking actuator 21. Since the second instruction braking force BPTr2 reaches the second target braking force BPS2 at timing T19, the second braking increase instruction processing is ended. That is, after the timing T19, the rear wheel braking force BPR is held.

Furthermore, when the first drive decrease instruction processing is executed, since the first instruction drive force DPTr1 is decreased, the drive force DP of the vehicle 10 is decreased by the driving of the power unit 31. The decrease speed of the drive force DP at this time corresponds to the increase speed of the rear wheel braking force BPR. That is, in the period from the timing T18 to the timing T19, the switching from the drive force DP to the rear wheel braking force BPR is performed. Then, the first drive decrease instruction processing is ended at the timing T19.

In this way, the first braking increase instruction processing and the second drive decrease instruction processing are started from the timing T19. When the first braking increase instruction processing is executed, since the first instruction braking force BPTr1 is increased, the front wheel braking force BPF is increased by the driving of the braking actuator 21. Since the first instruction braking force BPTr1 reaches the first target braking force BPS1 at timing T111, the first braking increase instruction processing is ended. That is, after the timing T111, the front wheel braking force BPF is held.

Furthermore, when the second drive decrease instruction processing is executed, since the first instruction drive force DPTr1 is decreased, the drive force DP of the vehicle 10 is decreased by the driving of the power unit 31. Then, the first instruction drive force DPTr1 becomes “0 (zero)” at timing T110. The decrease speed of the drive force DP at this time corresponds to the increase speed of the front wheel braking force BPF. That is, in the period from the timing T19 to the timing T110, the switching from the drive force DP to the front wheel braking force BPF is performed.

Here, a comparative example in which the front wheel braking force BPF and the rear wheel braking force BPR are simultaneously increased will be considered. In this comparative example, in a case where the drive force DP of the vehicle 10 is replaced with the braking force BP of the vehicle 10, the decrease speed of the drive force DP is increased. In this case, the occupant of the vehicle 10 easily feels sound and vibration generated by the decrease in the drive force DP from the power unit 31.

In this point, in the present embodiment, the increase in the rear wheel braking force BPR and the increase in the front wheel braking force BPF are temporally shifted. Therefore, the decrease speed of the drive force DP can be set to be lower than that in the case of the comparative example. According to this, the occupant of the vehicle 10 hardly feels sound and vibration generated by the decrease in the drive force DP from the power unit 31.

Furthermore, in the present embodiment, the drive force DP of the vehicle 10 is decreased simultaneously with the increase in the braking force BP of the vehicle 10. According to this, since the decrease in the drive force DP can be started early by comparing with the case where the decrease in the drive force DP is started after the increase in the braking force BP according to the execution of the braking increase control is completed, energy efficiency of the vehicle can be increased.

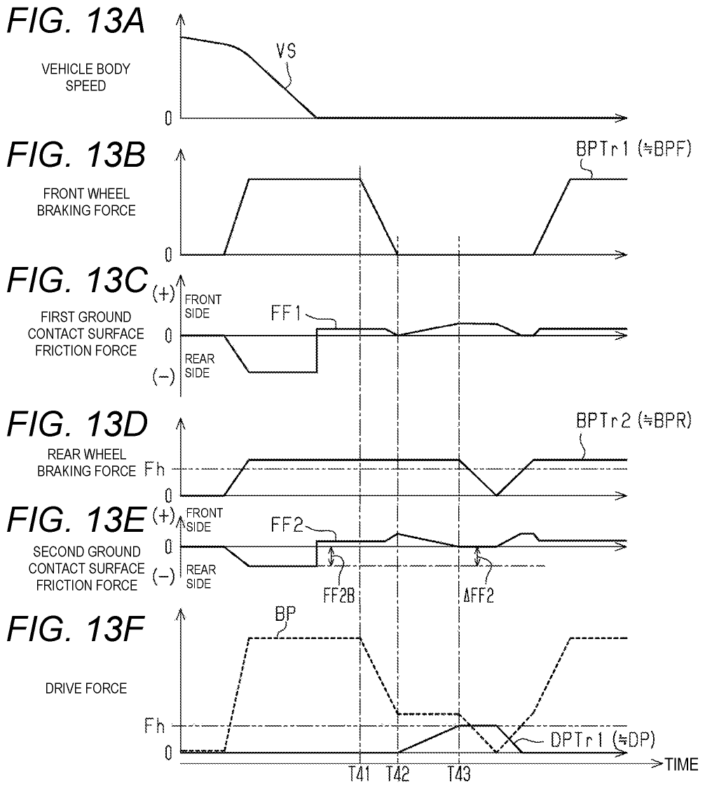

The example illustrated in FIG. 12 is an example of a case where the rear wheel braking force BPR before the start of the orientation control is smaller than the stop holding force Fh. There is a case where the rear wheel braking force BPR before the start of the orientation control is greater than the stop holding force Fh depending on the road surface gradient θ. FIG. 13 illustrates a timing chart in a case where the rear wheel braking force BPR before the start of the orientation control is greater than the stop holding force Fh.

As illustrated in FIGS. 13A, 13B, 13C, 13D, 13E, and 13F, when the vehicle 10 is stopped by applying the braking force to the front wheel 11 and the rear wheel 12, the first braking decrease instruction processing of the orientation control is started from timing T41. The first braking decrease instruction processing is executed until timing T42. Therefore, when the front wheel braking force BPF is decreased in a period from the timing T41 to the timing T42, the rotation of the front wheel 11 is permitted, and the position of the front wheel 11 in the vehicle front-rear direction X is returned to the reference position of the front wheel 11. Furthermore, the state of the suspension 13F for a front wheel is returned to the original state.

In the example illustrated in FIG. 13, the stop holding force Fh is smaller than the rear wheel braking force BPR. Therefore, during the execution of the first braking decrease instruction processing, the increase in the first instruction braking force BPTr1 is not started by the execution of the first drive increase instruction processing. Therefore, the first instruction drive force DPTr1 is increased by the execution of the second drive increase instruction processing started from the timing T42 at which the first braking decrease instruction processing is ended. When the first instruction drive force DPTr1 reaches the stop holding force Fh at timing T43, the second drive increase instruction processing is ended and the second braking decrease instruction processing is started. Note that, a flow of processing after the timing T43 is similar to the case of the example illustrated in FIG. 12, and thus the description thereof will be omitted.

### Second Embodiment

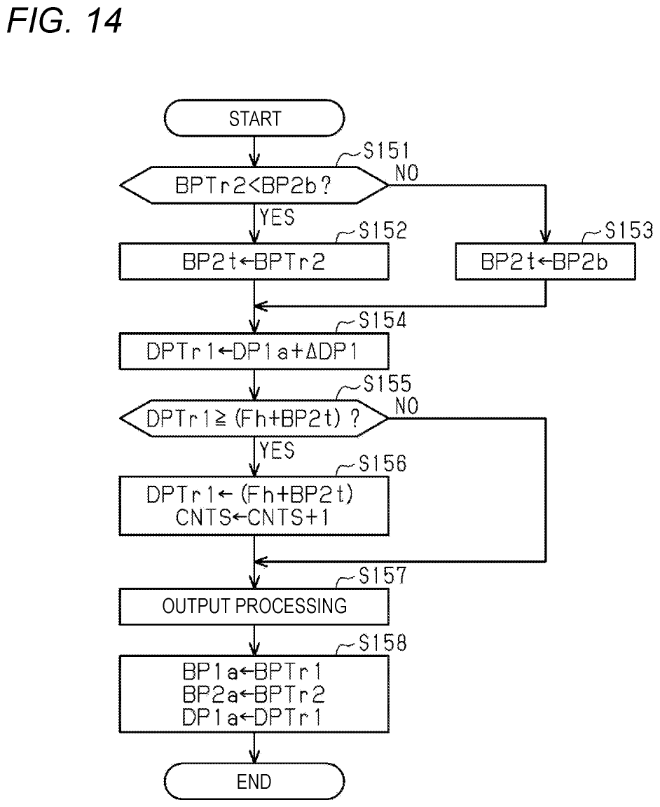

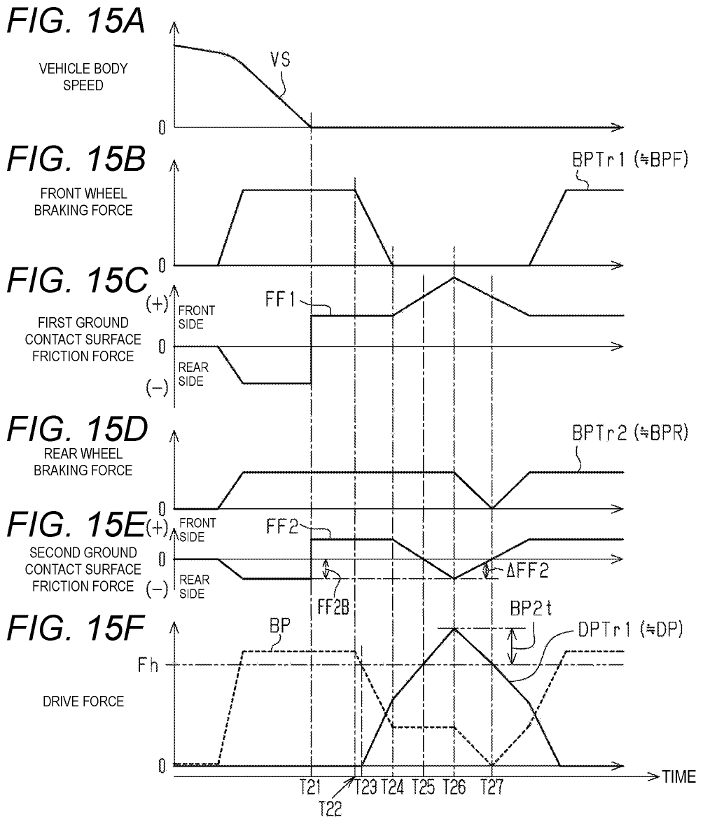

Hereinafter, a second embodiment of the vehicle control device will be described with reference to FIGS. 14 and 15. The second embodiment is different from the first embodiment in terms of the contents of some processing of the various processing to be executed. Therefore, in the following description, portions different from those of the first embodiment will be mainly described, the same reference numerals will be given to member configurations equal or corresponding to those of the first embodiment, and overlapped description will be omitted.

With reference to FIG. 14, the second drive increase instruction processing will be described in the present embodiment. The processing routine is executed by the orientation control unit 42.

In this processing routine, in Step S151, it is determined whether or not the second instruction braking force BPTr2 at a current time point is less than the second pre-stop braking force BP2b. The second pre-stop braking force BP2b is set in Step S12 of the processing routine described with reference to FIG. 5. In a case where the second instruction braking force BPTr2 is less than the second pre-stop braking force BP2b (S151: YES), the processing proceeds to next Step S152. In Step S152, the second instruction braking force BPTr2 is set as raising target force BP2t. Then, the processing proceeds to Step S154 to be described later.

On the other hand, in Step S151, in a case where the second instruction braking force BPTr2 is equal to or greater than the second pre-stop braking force BP2b (NO), the processing proceeds to next Step S153. In Step S153, the second pre-stop braking force BP2b is set as the raising target force BP2t. Then, the processing proceeds to next Step S154.

In Step S154, in a similar manner to Step S71, the sum of the first drive force previous value DP1a and the first drive increase amount ΔDP1 is calculated as the latest first instruction drive force DPTr1. Subsequently, in Step S155, it is determined whether or not the first instruction drive force DPTr1 calculated in Step S154 is equal to or greater than the sum of the stop holding force Fh and the raising target force BP2t. In a case where the first instruction drive force DPTr1 is equal to or greater than the sum thereof, the vehicle 10 is started when the drive force DP of the vehicle 10 is further increased. Then, in a case where the first instruction drive force DPTr1 is equal to or greater than the sum thereof (S155: YES), the processing proceeds to next Step S156. In Step S156, the sum of the stop holding force Fh and the raising target force BP2t is set as the first instruction drive force DPTr1, and the step counter CNTS is incremented by “one”. That is, the step counter CNTS is “three”. Then, the processing proceeds to next Step S157.

On the other hand, in Step S155, in a case where the first instruction drive force DPTr1 is smaller than the sum of the stop holding force Fh and the raising target force BP2t (NO), the processing proceeds to next Step S157. That is, the step counter CNTS is held as “two”.

In Step S157, in a similar manner to Step S74, output processing of outputting the first instruction drive force DPTr1 to the drive device 30 is executed. While the processing routine is executed repeatedly, the first instruction drive force DPTr1 output to the drive device 30 continues to increase. Therefore, the outputting of the first instruction drive force DPTr1 to the drive device 30 through the execution of the processing routine corresponds to instructing the drive device 30 to increase the drive force DP of the vehicle 10. Then, in next Step S158, in a similar manner to Step S22, the first instruction braking force BPTr1 at a current time point is set as the first braking force previous value BP1a, the second instruction braking force BPTr2 at a current time point is set as the second braking force previous value BP2a, and the first instruction drive force DPTr1 at a current time point is set as the first drive force previous value DP1a. After that, the processing routine is ended.

Next, the first drive decrease instruction processing will be described in the present embodiment. In the first embodiment, the first drive decrease instruction processing is started simultaneously with the second braking increase instruction processing. On the other hand, in the present embodiment, the first drive decrease instruction processing is started before the start of the second braking decrease instruction processing after the increase in the drive force DP of the vehicle 10 which is caused by the execution of the second drive increase instruction processing is completed. Specifically, the first drive decrease instruction processing is started when the increase in the drive force DP of the vehicle 10 which is caused by the execution of the second drive increase instruction processing is completed.

In the first drive decrease instruction processing executed in the present embodiment, the first instruction drive force DPTr1 is updated such that the first instruction drive force DPTr1 is decreased at a preset speed. The first drive decrease instruction processing is continued even after the start of the second braking increase instruction processing. When the second braking increase instruction processing is ended, the first drive decrease instruction processing is also ended.

Next, with reference to FIG. 15, portions different from those of the first embodiment among the actions and effects of the present embodiment will be mainly described.

As illustrated in FIGS. 15A, 15B, 15C, 15D, 15E, and 15F, the vehicle 10 is stopped at timing T21 by applying the braking force to the front wheel 11 and the rear wheel 12. In a period from the timing T21 to timing T22 at which the orientation control is started, the front wheel braking force BPF and the rear wheel braking force BPR are respectively held. Therefore, a state is maintained in which the position of the front wheel 11 in the vehicle front-rear direction X is different from the reference position of the front wheel 11, and the position of the rear wheel 12 in the vehicle front-rear direction X is different from the reference position of the rear wheel 12. That is, a state is maintained in which the wheel base WBL of the vehicle 10 is different from the reference wheel base WBLB.

Then, the first braking decrease instruction processing of the orientation control is started from the timing T22. The first braking decrease instruction processing is executed until timing T24. Therefore, when the front wheel braking force BPF is decreased in a period from the timing T22 to the timing T24, the rotation of the front wheel 11 is permitted, and the position of the front wheel 11 in the vehicle front-rear direction X is returned to the reference position of the front wheel 11. Furthermore, the state of the suspension 13F for a front wheel is returned to the original state.

Since the sum of the first instruction braking force BPTr1 and the second braking force previous value BP2a is less than the stop holding force Fh at timing T23 when the first braking decrease instruction processing is executed, the increase in the first instruction braking force BPTr1 is started by executing the first drive increase instruction processing of the orientation control. Then, since the first braking decrease instruction processing is ended at the timing T24, the drive increase instruction processing is switched from the first drive increase instruction processing to the second drive increase instruction processing.

The second drive increase instruction processing is continued even after timing T25 at which the first instruction drive force DPTr1 reaches the stop holding force Fh. Then, since the first instruction drive force DPTr1 reaches the sum of the stop holding force Fh and the raising target force BP2t at timing T26, the second drive increase instruction processing is ended. Accordingly, in the present embodiment, the drive force DP of the vehicle 10 can be increased to the sum of the stop holding force Fh and the raising target force BP2t or a value near the sum thereof by executing the second drive increase instruction processing. Note that, the sum of the stop holding force Fh and the raising target force BP2t is an upper limit value of the drive force DP at which the stop state of the vehicle 10 can be maintained, or a value near the upper limit value under a situation in which the braking force BP at a current time point is held.

Note that, by making the drive force DP of the vehicle 10 greater than the stop holding force Fh, the second ground contact surface friction force FF2 acts on the ground contact surface between the rear wheel 12 and the road surface toward the down-hill side. Then, at the timing T26 at which the drive force DP is equal to the sum of the stop holding force Fh and the raising target force BP2t, the second ground contact surface friction force FF2 becomes substantially equal to the second ground contact surface action force reference value FF2B which is the second ground contact surface friction force FF2 immediately before the timing T21 at which the vehicle 10 is stopped.

In the present embodiment, the second instruction braking force BPTr2, that is, the rear wheel braking force BPR is decreased by executing the second braking decrease instruction processing after the second ground contact surface friction force FF2 is made substantially equal to the second ground contact surface action force reference value FF2B. That is, when the deviation ΔFF2 described above is a value close to “0 (zero)”, the position of the rear wheel 12 in the vehicle front-rear direction X is returned to the reference position, and the state of the suspension 13R for a rear wheel is returned to the original state. At this time, since the position of the rear wheel 12 in the vehicle front-rear direction X can be more slowly displaced, it is possible to more gently change the orientation of the vehicle 10 according to the change of the wheel base WBL. Furthermore, since the effect of suppressing the sudden movement of the suspension 13R for a rear wheel can be increased, the effect of suppressing generation of vibration and sound caused by the movement of the suspension 13R for a rear wheel can be increased.

Since the rear wheel braking force BPR is decreased from the timing T26 according to the execution of the second braking decrease instruction processing, the first instruction drive force DPTr1, that is, the drive force DP of the vehicle 10 is decreased in accordance with the decrease of the rear wheel braking force BPR after the timing T26. Then, the first instruction drive force DPTr1 reaches the stop holding force Fh at timing T27 at which the second braking decrease instruction processing is ended. Therefore, the stop state of the vehicle 10 can be maintained even during the execution of the second braking decrease instruction processing.

### Third Embodiment

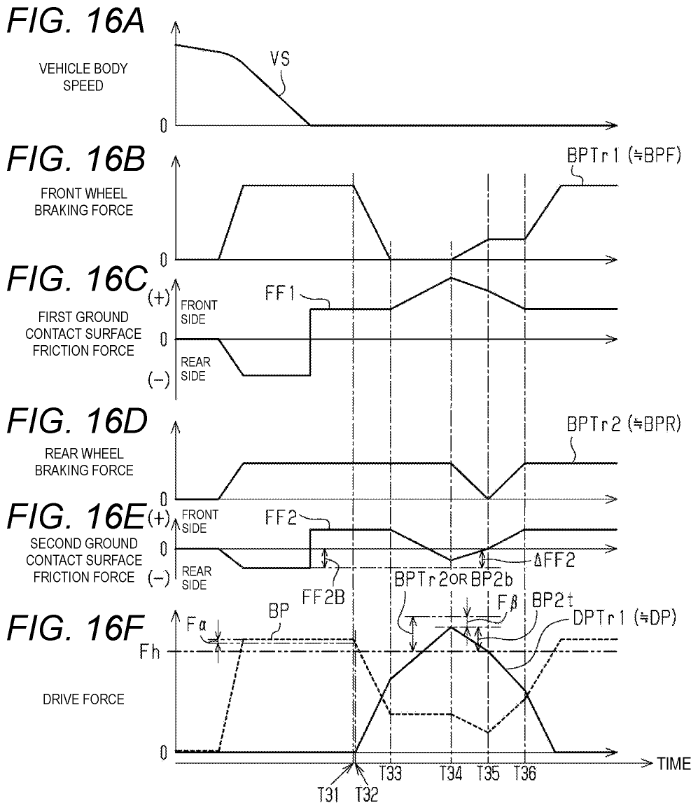

Hereinafter, a third embodiment of the vehicle control device will be described with reference to FIG. 16. The third embodiment is different from the second embodiment in terms of start timing of various processing, and the like. Therefore, in the following description, portions different from those of the first embodiment and the second embodiment will be mainly described, the same reference numerals will be given to member configurations equal or corresponding to those of the first embodiment and the second embodiment, and overlapped description will be omitted.

In the first drive increase instruction processing executed in the present embodiment, differences from the first drive increase instruction processing executed in the second embodiment will be mainly described.

In the first drive increase instruction processing executed in the present embodiment, in Step S55 illustrated in FIG. 7, it is determined whether or not the sum of the first instruction braking force BPTr1 and the second braking force previous value BP2a is equal to or greater than the sum of the stop holding force Fh and a first correction amount Fα. A value corresponding to the road surface gradient θ is set as the stop holding force Fh, but there is a possibility that the road surface gradient θ includes a derivation error. In a case where the road surface gradient θ is smaller than a gradient of an actual road surface, when the increase in the drive force DP of the vehicle 10 is started after the sum of the first instruction braking force BPTr1 and the second braking force previous value BP2a is less than the stop holding force Fh, there is a possibility that the vehicle 10 slides down due to the decrease in the braking force of the first wheel which is caused by the execution of the first braking decrease instruction processing. Accordingly, a value corresponding to the derivation error of the road surface gradient θ or a value greater than the value corresponding to the derivation error is set as the first correction amount Fα.

In a case where the sum of the first instruction braking force BPTr1 and the second braking force previous value BP2a is equal to or greater than the sum of the stop holding force Fh and the first correction amount Fα (S55: YES), the processing proceeds to Step S56, and “0 (zero)” is set as the first instruction drive force DPTr1. That is, the increase in the drive force DP is not started yet. On the other hand, when the sum of the first instruction braking force BPTr1 and the second braking force previous value BP2a is less than the sum of the stop holding force Fh and the first correction amount Fα (S55: NO), the processing proceeds to Step S57. In Step S57, a value obtained by subtracting the sum of the stop holding force Fh and the first correction amount Fα from the sum of the first instruction braking force BPTr1 and the second braking force previous value BP2a is calculated as the first instruction drive force DPTr1.

Note that, the contents of each processing after Step S58 are the same as those of the first embodiment and the second embodiment, and thus the description thereof will be omitted.

Next, in the second drive increase instruction processing executed in the present embodiment, differences from the second drive increase instruction processing executed in the second embodiment will be mainly described.

In the second drive increase instruction processing executed in the present embodiment, in Step S151 illustrated in FIG. 14, it is determined whether or not the second instruction braking force BPTr2 at a current time point is less than the second pre-stop braking force BP2b. In a case where the second instruction braking force BPTr2 is less than the second pre-stop braking force BP2b (S151: YES), the processing proceeds to next Step S152. In Step S152, a value obtained by subtracting a second correction amount Fβ, from the second instruction braking force BPTr2 is set as the raising target force BP2t. Then, the processing proceeds to Step S154 to be described later. On the other hand, in Step S151, in a case where the second instruction braking force BPTr2 is equal to or greater than the second pre-stop braking force BP2b (NO), the processing proceeds to next Step S153. In Step S153, a value obtained by subtracting the second correction amount Fβ, from the second pre-stop braking force BP2b is set as the raising target force BP2t. Then, the processing proceeds to next Step S154.

As described above, there is a possibility that the stop holding force Fh includes a derivation error component of the road surface gradient θ. Furthermore, there is also a possibility that a divergence occurs between the second instruction braking force BPTr2 and an actual rear wheel braking force BPR. When the raising target force BP2t is not set in consideration of such an error component, there is a possibility that the stop state of the vehicle 10 cannot be maintained when the first instruction drive force DPTr1 is increased to the sum of the stop holding force Fh and the raising target force BP2t. Therefore, the second correction amount Fβ, is set in consideration of the derivation error of the stop holding force Fh and the divergence between the second instruction braking force BPTr2 and the actual rear wheel braking force BPR.

Note that, the contents of each processing after Step S154 are the same as those of the second embodiment, and thus the description thereof will be omitted.

Next, the first braking increase instruction processing will be described in the present embodiment.

The first braking increase instruction processing executed in the present embodiment is started when the second drive increase instruction processing is ended. That is, the first braking increase instruction processing is started simultaneously with the second braking decrease instruction processing and the first drive decrease instruction processing.

The first braking increase instruction processing includes first increase instruction period processing, holding period processing executed after the end of the first increase instruction period processing, and second increase instruction period processing executed after the end of the holding period processing. In the first increase instruction period processing, the first instruction braking force BPTr1 is increased at a speed lower than the speed corresponding to the first braking increase amount ΔBP11. When the second braking decrease instruction processing and the first drive decrease instruction processing are ended and the second braking increase instruction processing is started, the first increase instruction period processing is also ended.

The holding period processing is executed during the execution of the second braking increase instruction processing. In the holding period processing, the first instruction braking force BPTr1 is held. That is, in the present embodiment, when the braking force of the second wheel is increased due to the execution of the second braking increase instruction processing, the braking force of the first wheel is maintained. When the second braking increase instruction processing is ended, the holding period processing is also ended.

The second increase instruction period processing is executed during the execution of the second drive decrease instruction processing. In the second increase instruction period processing, the first instruction braking force BPTr1 is increased at a speed corresponding to the first braking increase amount ΔBP11 until the first instruction braking force BPTr1 reaches the first target braking force BPS1.

Next, with reference to FIG. 16, portions different from those of the first embodiment and the second embodiment among the actions and effects of the present embodiment will be mainly described.

As illustrated in FIGS. 16A, 16B, 16C, 16D, 16E, and 16F, when the vehicle 10 is stopped by applying the braking force to the front wheel 11 and the rear wheel 12, the first braking decrease instruction processing of the orientation control is started from timing T31. The first braking decrease instruction processing is executed until timing T33. Therefore, when the front wheel braking force BPF is decreased in a period from the timing T31 to the timing T33, the rotation of the front wheel 11 is permitted, and the position of the front wheel 11 in the vehicle front-rear direction X is returned to the reference position of the front wheel 11. Furthermore, the state of the suspension 13F for a front wheel is returned to the original state.

Since the sum of the first instruction braking force BPTr1 and the second braking force previous value BP2a is less than the sum of the stop holding force Fh and the first correction amount Fα at timing T32 when the first braking decrease instruction processing is executed, the increase in the first instruction drive force DPTr1 is started by executing the first drive increase instruction processing of the orientation control. In this manner, by starting the increase in the drive force DP of the vehicle 10 before the timing at which the sum of the first instruction braking force BPTr1 and the second braking force previous value BP2a is less than the stop holding force Fh, the effect of preventing the vehicle 10 from sliding down due to the decrease in the front wheel braking force BPF can be increased. Then, since the first braking decrease instruction processing is ended at the timing T33, the drive increase instruction processing is switched from the first drive increase instruction processing to the second drive increase instruction processing.

At timing T34 at which the first instruction drive force DPTr1 reaches the sum of the stop holding force Fh and the raising target force BP2t by executing the second drive increase instruction processing, the second drive increase instruction processing is ended. In the present embodiment, the raising target force BP2t is set in consideration of the second correction amount F. Therefore, even when the drive force DP of the vehicle 10 is increased until the drive force DP becomes equal to the sum of the stop holding force Fh and the raising target force BP2t, the effect of suppressing the unintended start of the vehicle 10 can be increased.

Moreover, in the present embodiment, from the timing T34, in addition to the second braking decrease instruction processing and the first drive decrease instruction processing, the first increase instruction period processing in the first braking increase instruction processing is started. According to this, the decreases in the rear wheel braking force BPR and the drive force DP of the vehicle 10 are respectively decreased, but the front wheel braking force BPF is increased. As a result, it is possible to increase the effect of preventing the vehicle 10 from sliding down when the rear wheel braking force BPR and the drive force DP of the vehicle 10 are respectively decreased.

Then, at timing T35 at which the second instruction braking force BPTr2 is “0 (zero)” due to the execution of the second braking decrease instruction processing, the second braking decrease instruction processing is ended, and the second braking increase instruction processing is started. At the timing T35, the rear wheel braking force BPR is substantially “0 (zero)”, but the braking force is applied to the front wheel 11. Therefore, even when there is a slight divergence between the drive force DP and the stop holding force Fh, it is possible to prevent the vehicle 10 from sliding down or suppress the unintended start of the vehicle 10. Furthermore, in the first braking increase instruction processing, the first increase instruction period processing is ended and the holding period processing is started. Therefore, the front wheel braking force BPF is held during the period in which the rear wheel braking force BPR is increased. Then, when the second instruction braking force BPTr2 reaches the second target braking force BPS2 at timing T36, the second braking increase instruction processing is ended. Furthermore, the first drive decrease instruction processing is ended, and the second drive decrease instruction processing is started. Moreover, in the first braking increase instruction processing, the holding period processing is ended and the second increase instruction period processing is started.

### Modified Example

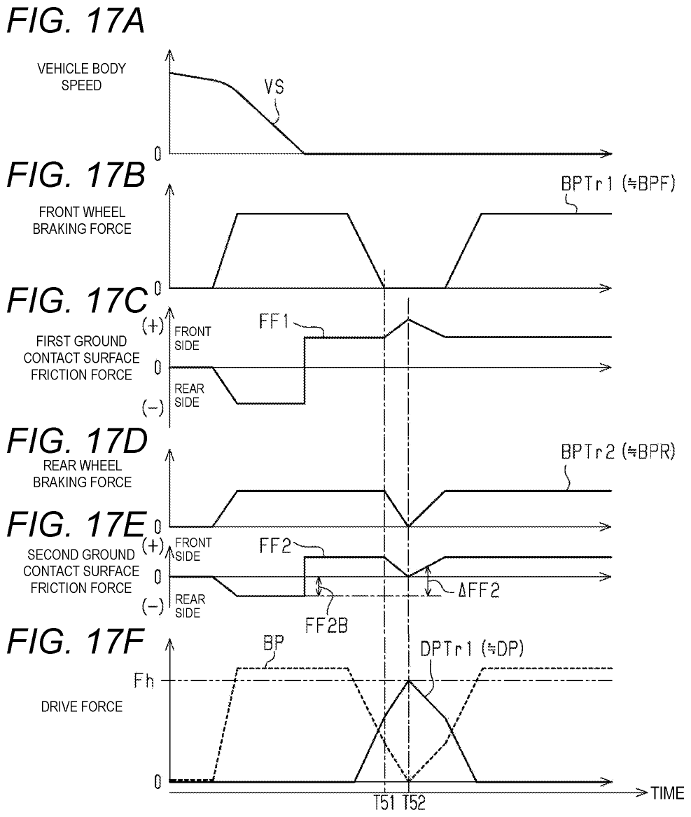

Each of the present embodiments described above can be modified and implemented as follows. The present embodiments and the following modified example can be implemented in combination with each other within a range not technically contradictory.
In each of the present embodiments described above, the decrease in the drive force DP of the vehicle 10 due to the execution of the drive decrease control is completed before the increase in the braking force BP of the vehicle 10 due to the execution of the braking increase control is completed. However, the decrease in the drive force DP of the vehicle 10 due to the execution of the drive decrease control may be completed after the increase in the braking force BP of the vehicle 10 due to the execution of the braking increase control is completed.
In the first embodiment and the second embodiment, the drive decrease control may be started after the braking increase control is ended.
In the first embodiment and the second embodiment, when it can be predicted that the vehicle 10 is started relatively early after the vehicle 10 is stopped, the braking increase control may not be executed.
In the braking increase control executed in the first embodiment and the second embodiment, the first braking increase instruction processing is started after the second braking increase instruction processing is ended. However, when the braking force BP of the vehicle 10 can be increased by the execution of the braking increase control, the first braking increase instruction processing may be started during the execution of the second braking increase instruction processing.
In the braking increase control executed in the first embodiment and the second embodiment, the second braking increase instruction processing is started before the first braking increase instruction processing. However, when the braking force BP of the vehicle 10 can be increased by the execution of the braking increase control, the first braking increase instruction processing may be started simultaneously with the second braking increase instruction processing. Furthermore, the first braking increase instruction processing may be started before the second braking increase instruction processing.
In the first embodiment and the second embodiment, when the braking force BP of the vehicle 10 can be increased by the execution of the braking increase control and the stop state of the vehicle 10 can be maintained with the braking force BP, both the front wheel braking force BPF and the rear wheel braking force BPR may not be increased by the execution of the braking increase control. For example, the braking increase control may be control for instructing the braking device 20 to increase only one of the front wheel braking force BPF and the rear wheel braking force BPR.
In the first embodiment, as illustrated in FIG. 12, the second braking decrease instruction processing is started in a state in which the second drive increase instruction processing is ended and the first instruction drive force DPTr1 is held by the stop holding force Fh. However, when the stop state of the vehicle 10 can be maintained during the orientation control, the second braking decrease instruction processing may be started before the second drive increase instruction processing is ended. For example, as illustrated in FIGS. 17A, 17B, 17C, 17D, 17E, and 17F, the second braking decrease instruction processing may be started from timing T51 at which the second drive increase instruction processing is started, the timing T51 being after the first braking decrease instruction processing is ended. In the example illustrated in FIG. 17, the second braking decrease instruction processing is executed such that the second instruction braking force BPTr2 is “0 (zero)” at timing T52 at which the first instruction drive force DPTr1 reaches the stop holding force Fh according to the second drive increase instruction processing. However, the present disclosure is not limited to this, and the second braking decrease instruction processing may be executed such that the second instruction braking force BPTr2 is “0 (zero)” after the timing T52.
In the first embodiment, when the second braking decrease instruction processing is executed, the braking force may be applied to the front wheel 11 as in the third embodiment.
The vehicle including the orientation control device 40 may include a drive device that outputs the drive force to the rear wheel 12 and does not output the drive force to the front wheel 11. In a case where the drive device is controlled in the orientation control, the rear wheel 12 corresponds to the first wheel, and the front wheel 11 corresponds to the second wheel.
The orientation control may be executed when the vehicle is stopped on a down-hill road. In this case, in the orientation control, instruction drive force that the drive force moving the vehicle backward is output from the power unit 31 to the first wheel is output to the drive control unit 32. According to this, it is possible to decrease the front wheel braking force BPF and the rear wheel braking force BPR while preventing the vehicle 10 from moving toward the down-hill side with the drive force DP of the vehicle.
The orientation control device 40 may have any of the following configurations (a) to (c).
(a) One or more processors that execute various processing according to a computer program is provided. The processor includes a CPU and a memory such as a RAM and a ROM. The memory stores a program code or a command configured to cause the CPU to execute processing. The memory, that is, a computer-readable medium includes any available medium that can be accessed by a general-purpose or dedicated computer.
(b) One or more dedicated hardware circuits that execute various processing are provided. Examples of the dedicated hardware circuit include an application specific integrated circuit, that is, an ASIC or an FPGA. The ASIC is an abbreviation of “Application Specific Integrated Circuit”, and the FPGA is an abbreviation of “Field Programmable Gate Array”.
(c) A processor that executes a part of various processing according to a computer program and a dedicated hardware circuit that executes the remaining processing among the various processing are provided.
The braking control unit 22 of the braking device 20 may have any of the configurations (a) to (c) described above.
The drive control unit 32 of the drive device 30 may have any of the configurations (a) to (c) described above.

1. (canceled)

2. (canceled)

3. (canceled)

4. (canceled)

5. (canceled)

6. (canceled)

7. (canceled)

8. (canceled)

9. A vehicle control device that controls a drive device and a braking device of a vehicle, the vehicle control device comprising:
an orientation control unit configured to, in a case where the vehicle is stopped on a slope road by applying braking force to a front wheel and a rear wheel of the vehicle, instruct the braking device to decrease braking force of the front wheel and braking force of the rear wheel, and execute orientation control for instructing the drive device to increase drive force of the vehicle in a range in which a stop state of the vehicle is maintained; and
a braking increase instruction unit configured to execute braking increase control for instructing the braking device to increase the braking force of at least one of the front wheel and the rear wheel after the increase in the drive force of the vehicle in accordance with the execution of the orientation control is ended,
wherein, of the front wheel and the rear wheel, the drive device outputs drive force to one wheel, and does not output the drive force to the other wheel, and
in a case where, of the front wheel and the rear wheel, the wheel to which the drive force is output from the drive device is a first wheel and the wheel to which the drive force is not output from the drive device is a second wheel,
the orientation control includes first braking decrease instruction processing of instructing the braking device to decrease the braking force of the first wheel and second braking decrease instruction processing of instructing the braking device to decrease the braking force of the second wheel after the braking force of the first wheel is decreased by driving the braking device based on execution of the first braking decrease instruction processing.

10. The vehicle control device according to claim 9, wherein the orientation control includes drive increase instruction processing of instructing the drive device to increase the drive force of the vehicle, and
in the orientation control, the orientation control unit starts
the drive increase instruction processing after the decrease in the braking force of the first wheel in accordance with the driving of the braking device based on the execution of the first braking decrease instruction processing, and
the second braking decrease instruction processing after the first braking decrease instruction processing is ended and after the increase in the drive force of the vehicle in accordance with the driving of the drive device based on the execution of the drive increase instruction processing is started.

11. The vehicle control device according to claim 10, wherein in the drive increase instruction processing during the execution of the first braking decrease instruction processing, the orientation control unit instructs the drive device to increase the drive force of the vehicle such that a sum of excessive drive force which is a value obtained by subtracting the braking force of the first wheel from the drive force of the vehicle and the braking force of the second wheel is equal to or greater than a stop state maintaining force which is force necessary for maintaining a stop state of the vehicle against an action of gravity.

12. The vehicle control device according to claim 11, wherein in the drive increase instruction processing after the first braking decrease instruction processing is ended, the orientation control unit instructs the drive device to increase the drive force to the stop state maintaining force.

13. The vehicle control device according to claim 12, wherein the braking increase control includes first braking increase instruction processing of instructing the braking device to increase the braking force of the first wheel, and second braking increase instruction processing of instructing the braking device to increase the braking force of the second wheel, and
in the braking increase control, the braking increase instruction unit starts
the first braking increase instruction processing after the decrease in the braking force of the first wheel in accordance with the driving of the braking device based on the execution of the first braking decrease instruction processing is ended, and
the second braking increase instruction processing after the decrease in the braking force of the second wheel in accordance with the driving of the braking device based on the execution of the second braking decrease instruction processing is ended.

14. The vehicle control device according to claim 13, wherein
in the braking increase control, the braking increase instruction unit starts
the second braking increase instruction processing before the first braking increase instruction processing, and
the first braking increase instruction processing after the decrease in the braking force of the first wheel in accordance with the driving of the braking device based on the execution of the first braking decrease instruction processing and after the increase in the braking force of the second wheel in accordance with the driving of the braking device based on the execution of the second braking increase instruction processing is started.

15. The vehicle control device according to claim 11, wherein the braking increase control includes first braking increase instruction processing of instructing the braking device to increase the braking force of the first wheel, and second braking increase instruction processing of instructing the braking device to increase the braking force of the second wheel, and
in the braking increase control, the braking increase instruction unit starts
the first braking increase instruction processing after the decrease in the braking force of the first wheel in accordance with the driving of the braking device based on the execution of the first braking decrease instruction processing is ended, and
the second braking increase instruction processing after the decrease in the braking force of the second wheel in accordance with the driving of the braking device based on the execution of the second braking decrease instruction processing is ended.

16. The vehicle control device according to claim 15, wherein
in the braking increase control, the braking increase instruction unit starts
the second braking increase instruction processing before the first braking increase instruction processing, and
the first braking increase instruction processing after the decrease in the braking force of the first wheel in accordance with the driving of the braking device based on the execution of the first braking decrease instruction processing and after the increase in the braking force of the second wheel in accordance with the driving of the braking device based on the execution of the second braking increase instruction processing is started.

17. The vehicle control device according to claim 10, wherein the braking increase control includes first braking increase instruction processing of instructing the braking device to increase the braking force of the first wheel, and second braking increase instruction processing of instructing the braking device to increase the braking force of the second wheel, and
in the braking increase control, the braking increase instruction unit starts
the first braking increase instruction processing after the decrease in the braking force of the first wheel in accordance with the driving of the braking device based on the execution of the first braking decrease instruction processing is ended, and
the second braking increase instruction processing after the decrease in the braking force of the second wheel in accordance with the driving of the braking device based on the execution of the second braking decrease instruction processing is ended.

18. The vehicle control device according to claim 17, wherein
in the braking increase control, the braking increase instruction unit starts
the second braking increase instruction processing before the first braking increase instruction processing, and
the first braking increase instruction processing after the decrease in the braking force of the first wheel in accordance with the driving of the braking device based on the execution of the first braking decrease instruction processing and after the increase in the braking force of the second wheel in accordance with the driving of the braking device based on the execution of the second braking increase instruction processing is started.

19. The vehicle control device according to claim 18, further comprising a drive decrease instruction unit configured to execute drive decrease control for instructing the drive device to decrease the drive force of the vehicle after the increase in the drive force of the vehicle in accordance with the execution of the orientation control is ended,
wherein in the drive decrease control, the drive decrease instruction unit instructs the drive device to decrease the drive force of the vehicle at a speed corresponding to an increase speed of the braking force when the braking force of the vehicle is increased by the driving of the braking device based on the execution of the braking increase control.

20. The vehicle control device according to claim 17, further comprising a drive decrease instruction unit configured to execute drive decrease control for instructing the drive device to decrease the drive force of the vehicle after the increase in the drive force of the vehicle in accordance with the execution of the orientation control is ended,
wherein in the drive decrease control, the drive decrease instruction unit instructs the drive device to decrease the drive force of the vehicle at a speed corresponding to an increase speed of the braking force when the braking force of the vehicle is increased by the driving of the braking device based on the execution of the braking increase control.
